(19) United States
(12) Patent Application Publication
(10) Pub. No.: US 2024/0351182 A1
(43) Pub. Date: Oct. 24, 2024

(54) HANDHELD POWER TOOL AND ONE-HANDED SAW

(71) Applicant: Nanjing Chervon Industry Co., Ltd., Nanjing (CN)

(72) Inventors: Zhongquan Xu, Nanjing (CN); Huaguo Zhu, Nanjing (CN); Keqiong Zhong, Nanjing (CN); Mingshun E, Nanjing (CN); Haoyu Wang, Nanjing (CN); Jianye Zhao, Nanjing (CN); Yang Li, Nanjing (CN)

(21) Appl. No.: 18/762,035

(22) Filed: Jul. 2, 2024

Related U.S. Application Data
(63) Continuation-in-part of application No. PCT/CN2023/094676, filed on May 17, 2023.

(30) Foreign Application Priority Data
May 23, 2022 (CN) 202210565167.7
Sep. 16, 2022 (CN) 202211130489.5
Aug. 8, 2023 (CN) 202322114143.2
Aug. 8, 2023 (CN) 202322134199.4
Aug. 8, 2023 (CN) 202421069609.X
May 15, 2024 (CN) 202421060925.0

(51) Int. Cl. B25F 5/02; A01G 3/033; A01G 3/037; A01G 3/053; A01G 3/08

(52) U.S. Cl. CPC B25F 5/02; A01G 3/0335; A01G 3/037; A01G 3/086; A01G 3/053

(57) ABSTRACT

A handheld power tool includes a motor, a handle having a first switch for starting and stopping the motor, an output assembly, and an adjustment device including a telescopic rod assembly. The length of the adjustment device changes so that the handheld power tool has at least first and second working states. The distance between the frontmost side of the handheld power tool and the rearmost side of the first switch is an effective length of the handheld power tool. When the handheld power tool is in the first working state, the handheld power tool has a first effective length T1. When the handheld power tool is in the second working state, the handheld power tool has a second effective length T2. The first effective length T1 is less than or equal to 1 m, and the second effective length T2 is greater than the first effective length T1.

### RELATED APPLICATION INFORMATION

This application is a continuation-in-part of International Application Number PCT/CN2023/094676, filed on May 17, 2023, through which this application also claims the benefit under 35 U.S.C. § 119 (a) of Chinese Patent Application No. 202210565167.7, filed on May 23, 2022, and Chinese Patent Application No. 202211130489.5, filed on Sep. 16, 2022, which applications are incorporated herein by reference in their entireties.

This application also claims the benefit under 35 U.S.C. § 119 (a) of Chinese Patent Application No. 202322114143.2, filed on Aug. 8, 2023, Chinese Patent Application No. 202322134199.4, filed on Aug. 8, 2023, Chinese Patent Application No. 202421069609.X, filed on Aug. 8, 2023, and Chinese Patent Application No. 202421060925.0, filed on May 15, 2024, which applications are incorporated herein by reference in their entireties.

### BACKGROUND

A chainsaw, also known as a hedge trimmer, is often used for pruning branches or forest trees. The chainsaw is generally a portable small or medium-sized chainsaw. Currently, the portable small or medium-sized chainsaw has a relatively low cutting height and cannot satisfy a working condition in which an object to be cut is slightly higher. A pole saw can satisfy high-position cutting, but cannot satisfy the convenience, lightweight, and flexibility of the portable small or medium-sized chainsaw. In addition to the chainsaw, other handheld power tools, such as electric scissors, a mower, and a handheld circular saw, also face the preceding situation. For portable handheld power tools, the user expects the tools to be compact and lightweight while satisfying the requirements of different pruning heights.

In addition, one-handed saws are common in the field of power tools. A one-handed saw is generally a sawing power tool that is operable by the user with just one hand. According to different purposes and working conditions, the one-handed saws may generally be divided into a one-handed chainsaw, a mini chainsaw, a one-handed reciprocating saw, a mini reciprocating saw, a one-handed electric circular saw, a mini electric circular saw, and the like.

### SUMMARY

A handheld power tool includes a motor; a handle for a user to hold, where a first switch is disposed on the handle and configured to at least control the starting and stopping of the motor; and an output assembly configured to perform an output operation. An adjustment device including a telescopic rod assembly is further included, where the length of the adjustment device changes so that the handheld power tool has at least two working states, that is, a first working state and a second working state. The distance between the frontmost side of the handheld power tool and the rearmost side of the first switch is defined as the effective length of the handheld power tool; where when the handheld power tool is in the first working state, the handheld power tool has a first effective length T1; and when the handheld power tool is in the second working state, the handheld power tool has a second effective length T2; where the first effective length T1 is less than or equal to 1 m, and the second effective length T2 is greater than the first effective length T1.

In an example, the difference between the second effective length T2 and the first effective length T1 is greater than or equal to 10 cm.

In an example, the difference between the second effective length T2 and the first effective length T1 is greater than or equal to 20 cm.

In an example, the handheld power tool further includes a third effective length T3, where the third effective length T3 is greater than the second effective length T2, and the difference between the third effective length T3 and the second effective length T2 is greater than or equal to 10 cm.

In an example, the handheld power tool further includes a coupling portion configured to mount a battery pack, where the total weight of the handheld power tool to which the battery pack is mounted is less than or equal to 6 kg.

In an example, the adjustment device is telescopic to a first state and a second state along the front and rear direction of the handheld power tool.

In an example, an adjustment switch is further included, where at least part of the adjustment switch is disposed on the handle; a stop portion is disposed on the adjustment switch; and when the adjustment switch is in an unlocked state, the stop portion is located on a movement path of the first switch controlling the starting and stopping of the motor, and at this time, the first switch is restricted from implementing a function of starting the motor.

In an example, the adjustment device is provided with a locking hole, the adjustment switch further includes a button for the user to operate, a first seesaw rotatably connected to the handle, and a reset torsion spring connected to the first seesaw, the button is capable of pressing one end of the first seesaw, and the other end of the first seesaw is selectively inserted into the locking hole.

In an example, the adjustment device includes a first connecting rod connected to the handle and provided with the locking hole.

In an example, the handheld power tool further includes a body housing, where the motor is disposed in the body housing, the output assembly is at least partially disposed in the body housing, and the adjustment device further includes a second connecting rod connected to the body housing.

In an example, a locking assembly is disposed between the first connecting rod and the second connecting rod, and when both the first connecting rod and the second connecting rod extend out of the handle, the locking assembly locks the first connecting rod and the second connecting rod.

In an example, the handheld power tool further includes a coupling portion configured to mount a battery pack, where the handheld power tool further includes a spring wire, the spring wire is inserted through the handle and the adjustment device, one end of the spring wire is electrically connected to the motor, and the other end of the spring wire is electrically connected to the battery pack.

In an example, the handheld power tool further includes a power supply device for supplying electric power to at least the motor, where the power supply device is detachably connected to a rear part of the handle.

In an example, the first effective length T1 is less than or equal to 60 cm.

In an example, the first effective length T1 is less than or equal to 50 cm.

In an example, the adjustment device is at least partially disposed between the output assembly and the handle.

In an example, the handheld power tool is a chainsaw, electric scissors, a nail gun, or a reciprocating saw.

The present application further adopts the technical solution below. A handheld power tool includes a motor accommodated in a body housing; a handle for a user to hold; and an output assembly configured to perform an output operation. When the handheld power tool is placed on a horizontal plane, the maximum distance of the handheld power tool along the direction parallel to the horizontal plane is defined as the total length of the handheld power tool, and the total length is adjustable. The handheld power tool has at least two working states, that is, a first working state and a second working state; where when the handheld power tool is in the first working state, the handheld power tool has a first total length M1; and when the handheld power tool is in the second working state, the handheld power tool has a second total length M2; where the second total length M2 is greater than the first total length M1, and the first total length M1 is less than 1.2 m.

In an example, the handheld power tool includes only a first switch for controlling the starting and stopping of the motor, where the first switch is capable of controlling the starting and stopping of the motor when the handheld power tool is in different working states.

The present application further adopts the technical solution below. A one-handed saw includes a motor accommodated in a body housing; a handle for a user to hold; and an output assembly configured to perform an output operation. When the one-handed saw is placed on a horizontal plane, the maximum distance of the one-handed saw along the direction parallel to the horizontal plane is defined as the total length of the one-handed saw, and the total length is adjustable.

The present application further adopts the technical solution below. A chainsaw includes a body housing having a front part, a rear part, and an intermediate part between the front part and the rear part; an electric motor accommodated in the intermediate part of the body housing; a guide plate extending forward from the front part of the body housing; a chain disposed around the guide plate; a handle for a user to hold; a power supply device supplying power to at least the electric motor; and an adjustment device, where the body housing and the handle move relatively through the adjustment device along the extension direction of the adjustment device. The adjustment device includes a telescopic rod assembly having at least a first state and a second state. The length of the telescopic rod assembly in the second state along the front and rear direction is greater than the length of the telescopic rod assembly in the first state along the front and rear direction. In the second state, the center of gravity of the chainsaw is located between the center of the guide plate and the center of the handle.

In an example, the handle has a grip; and in the first state, the center of gravity of the chainsaw is located in the grip.

In an example, the centerline of the handle is basically parallel to the centerline of the guide plate.

In an example, the centerline of the handle is collinear with the centerline of the guide plate.

In an example, the telescopic rod assembly is telescopic along the direction of a first straight line, and the first straight line is basically parallel to the centerline of the guide plate.

In an example, the handle has an upper part and a lower part, a coupling portion is formed on or connected to the lower part of the handle, the power supply device is detachably connected to the coupling portion along the direction of a second straight line, and the second straight line is basically parallel to the centerline of the handle.

In an example, when the telescopic rod assembly is in the first state, the projection of the power supply device and the projection of the telescopic rod assembly on a projection plane perpendicular to a first plane where the guide plate is located at least partially coincide.

In an example, a bushing is disposed at the rear end of the telescopic rod assembly, guide ribs parallel to the centerline of the handle are disposed in the handle, and the bushing and the guide ribs mate with each other to guide the telescopic rod assembly to be telescopic along the direction of the first straight line.

In an example, the handle has an upper part and a lower part, and the chainsaw further includes a circuit board assembly disposed within the lower part of the handle.

In an example, when the telescopic rod assembly is in the first state, a second plane where the circuit board assembly is located is below the first straight line, and the projection of the circuit board assembly and the projection of the telescopic rod assembly on a projection plane perpendicular to the first plane where the guide plate is located at least partially coincide.

In an example, the chainsaw further includes a movable wire, a fixed wire, and a first switch disposed on the handle and used for starting and stopping the electric motor, where the movable wire is inserted through the handle and the adjustment device and electrically connected to the power supply device and the electric motor; and the fixed wire is disposed in the handle and electrically connected to the circuit board assembly and the first switch.

In an example, the chainsaw further includes a first switch for starting and stopping the electric motor and a second switch for locking the starting and stopping states of the electric motor, the first switch and the second switch are disposed on the handle, and the second switch is located in front of the first switch along the direction of the centerline of the handle.

In an example, in the first state, the adjustment device is at least partially accommodated in the handle.

In an example, the chainsaw further includes a support assembly disposed on the body housing and/or the handle, where the support assembly is used for supporting the chainsaw and keeping balance when the chainsaw is placed horizontally.

In an example, the chainsaw further includes a protective part below the handle, and the protective part is used for preventing a broken or fallen chain from injuring the hand of the user.

The present application further adopts the technical solution below. A chainsaw includes a body housing having a front part, a rear part, and an intermediate part between the front part and the rear part; an electric motor accommodated in the intermediate part of the body housing; a guide plate extending forward from the front part of the body housing; a chain disposed around the guide plate; a handle for a user to hold; a power supply device supplying power to at least the electric motor; and an adjustment device, where the body housing and the handle move relatively through the adjustment device along the extension direction of the adjustment device. The centerline of the handle is basically parallel to the centerline of the guide plate, and the power supply device is located below the centerline of the handle.

The present application further adopts the technical solution below. A chainsaw includes a body housing having a front part, a rear part, and an intermediate part between the front part and the rear part; an electric motor disposed in the intermediate part of the body housing; a guide plate extending from the front part of the body housing; a chain disposed around the guide plate; a handle used for a user to hold and having a front end surface and a rear end surface; and an adjustment device, where the body housing and the handle move relatively through the adjustment device along the extension direction of the adjustment device. The ratio of the body length of the body housing to the handle length of the handle is greater than or equal to 0.3 and less than or equal to 0.8, where the body length is the distance between the frontmost side of the front part of the body housing and the rearmost side of the rear part of the body housing, and the handle length is the distance between the front end surface of the handle and the rear end surface of the handle.

In an example, the ratio of the body length to the handle length is greater than or equal to 0.4 and less than or equal to 0.7.

In an example, the ratio of the output power of the chainsaw to the body length is greater than or equal to 1.5 W/mm and less than or equal to 3.5 W/mm.

In an example, the adjustment device includes a telescopic rod assembly, where the telescopic rod assembly is telescopic to at least a first state or a second state along the direction of a first straight line.

In an example, the ratio of the second length of the chainsaw in the second state to the first length of the chainsaw in the first state is greater than or equal to 1.4 and less than or equal to 2.8.

In an example, the second length of the chainsaw in the second state is greater than or equal to 800 mm.

In an example, the telescopic rod assembly includes at least a first connecting rod and a second connecting rod, where the inner diameter of the handle is greater than the outer diameter of the first connecting rod, and the inner diameter of the first connecting rod is greater than the outer diameter of the second connecting rod.

In an example, the ratio of the outer diameter of the handle to the outer diameter of the first connecting rod is less than or equal to 1.5.

In an example, the outer diameter of the handle is greater than or equal to 35 mm and less than or equal to 40 mm, and the outer diameter of the first connecting rod is greater than or equal to 25 mm and less than or equal to 30 mm.

In an example, the ratio of the outer diameter of the first connecting rod to the outer diameter of the second connecting rod is less than or equal to 1.5.

In an example, the weight of the chainsaw is less than or equal to 2.5 kg.

The present application further adopts the technical solution below. A chainsaw includes a body housing having a front part, a rear part, and an intermediate part between the front part and the rear part; an electric motor accommodated in the intermediate part of the body housing; a guide plate extending forward from the front part of the body housing; a chain disposed around the guide plate; a handle for a user to hold; a power supply device supplying power to at least the electric motor; and an adjustment device, where the body housing and the handle move relatively through the adjustment device along the extension direction of the adjustment device. The handle has a grip. The chainsaw further includes a protective part connected to the handle and located below the grip, and when the chain is disengaged from the guide plate, the protective part blocks the path on which the chain reaches the grip.

In an example, the adjustment device includes a telescopic rod assembly, where the telescopic rod assembly has multiple states in which the telescopic rod assembly has different lengths along the front and rear direction.

In an example, the chainsaw further includes a first switch for starting and stopping the electric motor, and the distance between the rearmost side of the chain exposed outside the body housing and the frontmost side of the first switch along the front and rear direction in at least one state of the telescopic rod assembly is greater than or equal to 125 mm.

In an example, the distance between the rearmost side of the chain exposed outside the body housing and the frontmost side of the first switch along the front and rear direction in at least one state of the telescopic rod assembly is less than or equal to 125 mm.

In an example, two ends of the protective part along the front and rear direction are connected to the handle, and the protective part and the handle form a through hole for the hand of the user to pass through.

In an example, the chainsaw further includes a first switch for starting and stopping the electric motor, and the distance between the frontmost side of the first switch and the rear edge of the through hole along the front and rear direction is greater than or equal to 100 mm.

In an example, in the projection along the up and down direction, the maximum value of the distance between the outer edge of the protective part on the same side as the guide plate and the outer edge of the handle on the same side as the guide plate in the left and right direction is greater than or equal to 30 mm.

In an example, the protective part supports and stabilizes the chainsaw when the chainsaw is placed horizontally.

In an example, the power supply voltage of the power supply device is greater than or equal to 12 V and less than or equal to 60 V.

### BRIEF DESCRIPTION OF THE DRAWINGS

FIG. 1 is a schematic view of a chainsaw and a handheld power tool as a first example of the present application.

FIG. 2 is an exploded view of the chainsaw and the handheld power tool shown in FIG. 1.

FIG. 3 is a schematic view of the chainsaw and the handheld power tool shown in FIG. 1 from another perspective.

FIG. 4 is a partial schematic view of the chainsaw and the handheld power tool with an adjustment device in a second state.

FIG. 5 is a schematic view of an adjustment device in a first state.

FIG. 6 is a partial exploded view of an adjustment device in a second state.

FIG. 7A is a schematic view of an adjustment device with a first length.

FIG. 7B is a schematic view of an adjustment device with a second length.

FIG. 8 is a schematic view of an adjustment switch and an adjustment device.

FIG. 9A is a schematic view of electric scissors as a second example of the present application.

FIG. 9B is a schematic view of the electric scissors in FIG. 9A in another state.

FIG. 10 is a schematic view of a chainsaw in a retracted state as a third example of the present application.

FIG. 11 is a schematic view of the chainsaw shown in FIG. 10 with a first connecting rod retracted and a second connecting rod extended.

FIG. 12 is a schematic view of the chainsaw in FIG. 11 from another perspective.

FIG. 13 is a schematic view of the chainsaw shown in FIG. 10 with both a first connecting rod and a second connecting rod extended.

FIG. 14 is schematic view one of the chainsaw shown in FIG. 10 with part of a handle omitted.

FIG. 15 is an enlarged view of part A in FIG. 14.

FIG. 16 is a sectional view of part of the structure of the chainsaw shown in FIG. 10.

FIG. 17 is schematic view two of the chainsaw shown in FIG. 10 with part of a handle omitted.

FIG. 18 is an enlarged view of part B in FIG. 17.

FIG. 19 is a schematic view of a locking assembly of the chainsaw shown in FIG. 17.

FIG. 20 is a schematic view of part of a handle of the chainsaw shown in FIG. 17.

FIG. 21 is a schematic view of the chainsaw shown in FIG. 13 from another perspective.

FIG. 22 is an enlarged view of part C in FIG. 21.

FIG. 23 is a schematic view of a nail gun as a fourth example of the present application.

FIG. 24 is a schematic view of a nail gun as a fourth example of the present application.

FIG. 25 is a schematic view of a chainsaw in an extended state as a fifth example of the present application.

FIG. 26 is a schematic view of the chainsaw shown in FIG. 25 in a retracted state.

FIG. 27 is a side view of the chainsaw and a handheld power tool in FIG. 10 placed on a horizontal plane.

FIG. 28 is a side view of the chainsaw and the handheld power tool in FIG. 27 in another working state placed on a horizontal plane.

FIG. 29 is a schematic view of an example of a chainsaw and a handheld power tool in a first working state.

FIG. 30 is a schematic view of the chainsaw and the handheld power tool in FIG. 29 in a second working state.

FIG. 31 is a perspective view of a chainsaw in a retracted state as an example of the present application.

FIG. 32 is an exploded view of the chainsaw shown in FIG. 31.

FIG. 33 is a perspective view of the chainsaw shown in FIG. 31 in an extended state.

FIG. 34 is a plan view of the chainsaw shown in FIG. 31.

FIG. 35 is a plan view of part of the internal structure of the chainsaw shown in FIG. 31.

FIG. 36 is a plan view of part of the internal structure of a handle in the chainsaw shown in FIG. 31.

FIG. 37 is a plan view illustrating the body length and the handle length of the chainsaw shown in FIG. 31.

FIG. 38 is a plan view of the first length of the chainsaw shown in FIG. 31.

FIG. 39 is a plan view of the second length of the chainsaw shown in FIG. 33.

FIG. 40 is a plan view illustrating the inner and outer diameters of a handle and the inner and outer diameters of a first connecting rod of the chainsaw shown in FIG. 31.

FIG. 41 is a plan view illustrating the inner and outer diameters of a first connecting rod and the inner and outer diameters of a second connecting rod of the chainsaw shown in FIG. 31.

FIG. 42 is a perspective view of a telescopic rod assembly in the chainsaw shown in FIG. 31 in a first state.

FIG. 43 is a sectional view of the telescopic rod assembly shown in FIG. 42 in the first state.

FIG. 44 is an exploded view of the telescopic rod assembly shown in FIG. 42 in the first state.

FIG. 45 is a perspective view of a telescopic rod assembly in the chainsaw shown in FIG. 33 in a second state.

FIG. 46 is a sectional view of the telescopic rod assembly shown in FIG. 45 in the second state.

FIG. 47 is an exploded view of the telescopic rod assembly shown in FIG. 45 in the second state.

FIG. 48 is a perspective view of a first locking assembly in a telescopic rod assembly shown in FIG. 31.

FIG. 49 is an exploded view of a second locking assembly in a telescopic rod assembly shown in FIG. 33.

FIG. 50 is a plan view of a protective part of the chainsaw shown in FIG. 31.

### DETAILED DESCRIPTION

In the description of the present application, it is to be noted that orientations or position relations indicated by terms such as “center”, “upper”, “lower”, “left”, “right”, “front”, and “rear” are based on the drawings. These orientations or position relations are intended only to facilitate and simplify the description of the present application and not to indicate or imply that a device or element referred to must have such particular orientations or must be configured or operated in such particular orientations. Thus, these orientations or position relations are not to be construed as limiting the present application. In addition, terms such as “first” and “second” are used merely for the purpose of description or are used for distinguishing between different structures or components, and are not to be construed as indicating or implying relative importance.

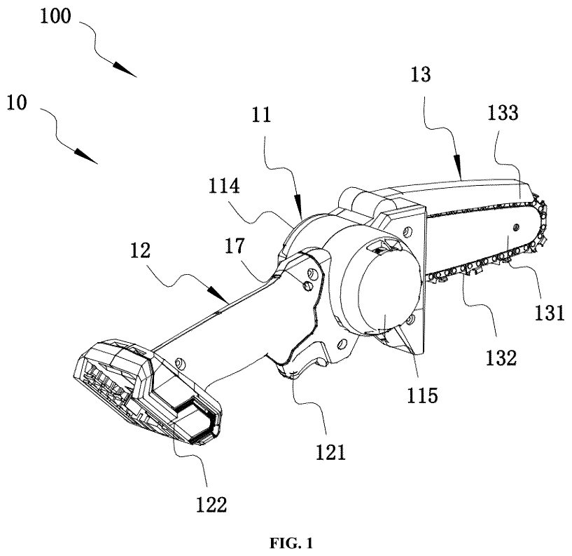

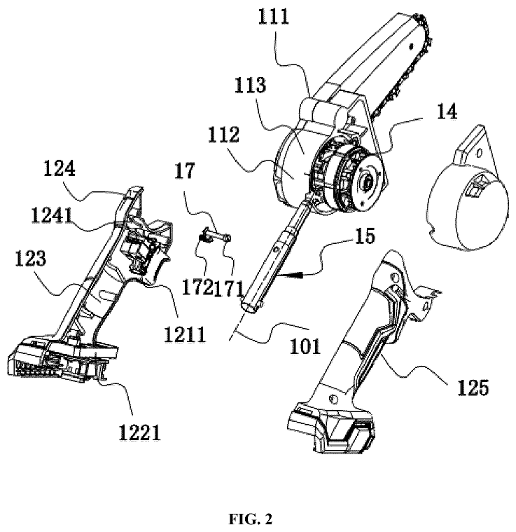

FIG. 1 shows a handheld power tool 10 as a first example. The handheld power tool 10 is, for example, a chainsaw 100 generally configured to prune branches or forest trees. As shown in FIGS. 1 and 2, the chainsaw 100 generally includes a body housing 11, an output assembly 13, a motor 14, a power supply device, and the like. The body housing 11 has a front part 111, a rear part 112, and an intermediate part 113 between the front part 111 and the rear part 112. For the chainsaw 100, the output assembly 13 is a cutting assembly and includes a chain 132, a guide plate 131 that supports the movement of the chain 132, and a protective cover 133 that protects the chain. The motor 14 is disposed in the intermediate part 113 of the body housing 11 and configured to drive the chain 132 to move around the guide plate 131 to implement the cutting operation. For example, the body housing 11 is formed by a left housing 114 and a right housing 115. In this example, the right housing 115 is configured to accommodate the motor 14, and the axial direction of the motor 14 is basically perpendicular to the plane where the guide plate 131 is located. The output assemblies 13 of other forms of handheld power tools 10 than the chainsaw 100 may be different from the output assembly 13 of the chainsaw 100.

The body housing 11 is further formed with a handle 12 for the user to hold. The handle 12 is disposed on the rear side of the body housing 11. For example, a first switch 121 is disposed at one end of the handle 12 facing the rear part 112 of the body housing 11, and a coupling portion 122 for connecting a power supply device 17 is formed at one end of the handle 12 facing away from the rear part 112 of the body housing 11. The first switch 121 is operable by the user and is configured to control the starting and stopping of the motor 14. In an example, the first switch 121 may be configured to adjust the rotational speed of the motor 14. In this example, the first motor 121 is a trigger. In other examples, the first switch 121 may be a switch that is pushable forward and backward or a switch that is togglable left and right. The power supply device 17 is connected to the coupling portion 122 and configured to supply electrical energy to the chainsaw 100. In this example, the power supply device is configured to be a battery pack. It is to be understood that the power supply device is not limited to the scenario of using the battery pack, and the power may be supplied to the circuit elements through mains power or an alternating current (AC) power supply in conjunction with the corresponding rectifier circuit, filter circuit, and voltage regulator circuit.

The handle 12 includes a left handle housing 124 and a right handle housing 125. The left handle housing 124 and the right handle housing 125 form an accommodation space 123. In this example, the first switch 121 is connected to an integrated switch 1211 and configured to control the rotational speed of the motor 14 to control the cutting speed of the chainsaw 100. For example, the integrated switch 1211 is disposed in the accommodation space 123 and corresponds to the first switch 121. The accommodation space 123 further accommodates a circuit board assembly 1221 that corresponds to the coupling portion 122 and is configured to control the power supply state of the power supply device 17 or communicate with the power supply device 17.

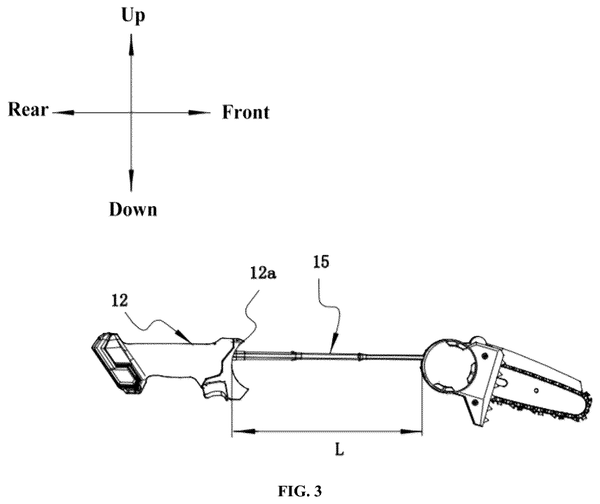

In this example, the handle 12 is formed with or connected to an adjustment device 15. The adjustment device 15 extends along the direction of a first straight line 101 and is connected to the rear part 112 of the body housing 11. The adjustment device 15 has a first state and a second state in the direction of the first straight line 101. FIG. 1 shows a schematic view of the adjustment device 15 in the chainsaw 100 in the first state, and FIG. 3 shows a schematic view of the adjustment device 15 in the chainsaw 100 in the second state. For example, when the adjustment device 15 is in the first state, at least part of a front end surface 12a of the handle 12 abuts against the rear part 112. It is to be understood that when the adjustment device 15 is in the first state, the front end surface 12a of the handle 12 does not abut against the rear part 112, but is separated by a relatively short distance. When the adjustment device 15 is in the second state, at least part of the adjustment device 15 is located between the rear part 112 of the body housing 11 and the front end surface 12a of the handle 12. It is to be understood that when the adjustment device 15 is in the first state, the adjustment device 15 can be completely disposed in the accommodation space 123 formed by the handle 12. When the adjustment device 15 is in the second state, at least part of the adjustment device 15 is located outside the accommodation space 123 formed by the handle 12.

For example, as shown in FIG. 3, the adjustment device 15 is disposed between the body housing 11 and the handle 12. The handle 12 is movable relative to the rear part 112 along the extension direction of the adjustment device 15. During the movement of the handle 12, the first distance L between the front end surface 12a of the handle 12 and the rear part 112 in the front and rear direction is greater than or equal to 0 and less than 1 meter. For example, the first distance L between the front end surface 12a of the handle 12 and the rear part 112 in the front and rear direction is greater than or equal to 0 and less than 0.8 meters. For example, the first distance L between the front end surface 12a of the handle 12 and the rear part 112 in the front and rear direction is greater than or equal to 0 and less than 0.6 meters. The first distance L may be understood as the maximum length of the part of the adjustment device 15 located between the handle 12 and the body housing 11. That is to say, during the movement of the handle 12, the maximum distance between the front end surface 12a of the handle 12 and the rear part 112 of the body housing 11 in the front and rear direction is greater than or equal to 0 and less than 1 meter.

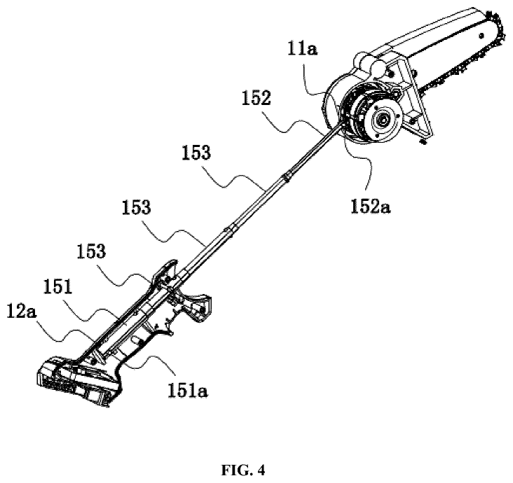

For example, as shown in FIG. 4, the adjustment device 15 includes at least a first connecting rod 151, a second connecting rod 152, and at least one intermediate connecting rod 153. The first connecting rod 151 is fixedly connected to the handle 12, the second connecting rod 152 is fixedly connected to the rear part 121 of the body housing 11, and the intermediate connecting rod 153 is disposed between the first connecting rod 151 and the second connecting rod 152. In this example, first fixing pins 151a are formed on or connected to the first connecting rod 151, multiple first through holes 12a are formed inside the handle 12, and two ends of the first fixing pin 151a are disposed in the first through hole 12a separately, thereby ensuring that the first connecting rod 151 is fixedly connected to the handle 12. Similarly, second fixing pins 152a are formed on or connected to the second connecting rod 152, multiple second through holes 11a are formed on the rear part 112 of the body housing 11, and two ends of the second fixing pin 152a are disposed in the second through hole 11a separately, thereby ensuring that the second connecting rod 152 can be fixedly connected to the body housing 11. It is to be understood that many methods in which the first connecting rod 151 is fixed to the handle 12 and the second connecting rod 152 is fixed to the rear part 121 of the body housing 11 exist, which are not limited here. Of course, those skilled in the art may provide a non-fixed connection method, for example, the first connecting rod can be slidably connected to the handle, or other examples, which are not limited here.

As shown in FIGS. 2 and 5, when the adjustment device 15 is in the first state, the adjustment device 15 can be completely disposed in the accommodation space 123 formed by the handle 12. For example, the intermediate connecting rod 153 is sleeved on the second connecting rod 152, and the first connecting rod 151 is sleeved on the intermediate connecting rod 153. It is to be understood that one intermediate connecting rod 153 may be provided. Of course, multiple intermediate connecting rods 153 may be provided. When multiple intermediate connecting rods are provided, the multiple intermediate connecting rods are sleeved together.

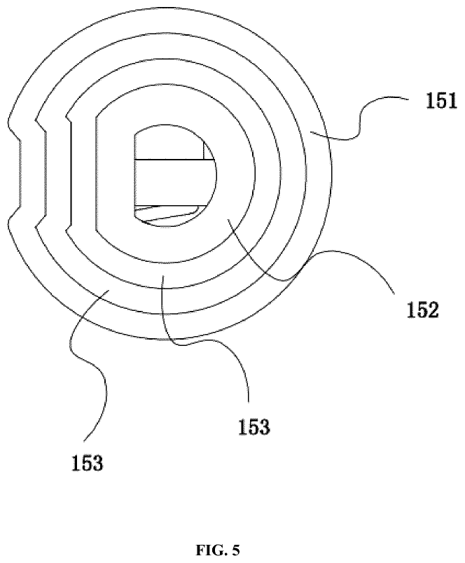

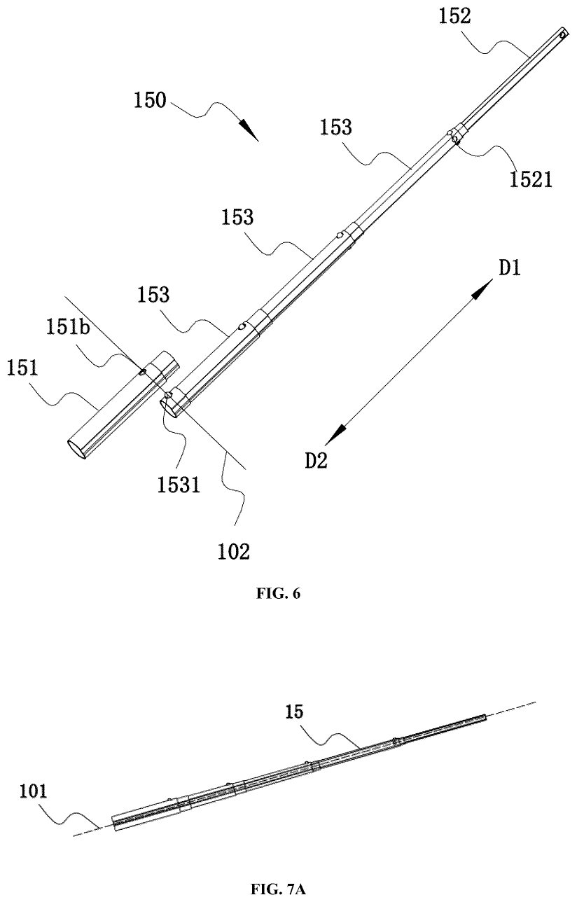

Referring to FIGS. 4 and 6, the adjustment device 15 further includes multiple locking members. The second connecting rod 152 and each intermediate connecting rod 153 are provided with the locking members. For example, the intermediate connecting rod 153 close to the first connecting rod 151 is used as an example for the detailed description of the working principle and function of the locking member.

As shown in FIG. 6, a first limiting member 1531 is formed on or connected to the intermediate connecting rod 152. The first limiting member 1531 has a first state and a second state in the direction of a second straight line 102. A first limiting portion is formed on the first connecting rod 151. For example, the first limiting portion is optionally configured to be a first limiting hole 151b. When the adjustment device 15 is in the first state, the first limiting member 1531 on the intermediate connecting rod 153 is in the first state. At this time, the first limiting member 1531 is located outside the first limiting hole 151b, and the first connecting rod 151 and the intermediate connecting rod 153 are movable relatively along the first direction D1 or the second direction D2. When the adjustment device 15 is in the second state, the first limiting member 1531 on the intermediate connecting rod 154 is in the second state. At this time, the first limiting member 1531 is disposed in the first limiting hole 151b, and the first connecting rod 151 and the intermediate connecting rod are relatively fixed.

In some examples, when the adjustment device 15 is in the second state, the adjustment device 15 has at least a first length and a second length in the direction of the first straight line 101. The first length is less than the second length. For example, when the adjustment device 15 has the first length, a second locking member 1521 is disposed at a limiting portion of the intermediate connecting rod 153, and the intermediate connecting rod 153 and the second connecting rod 152 are fixedly connected through the second locking member 1521. When the adjustment device 15 has the second length, a first locking member 1531 is disposed at a limiting portion of the first connecting rod 151, and the first connecting rod 151 and the intermediate connecting rod 153 are fixedly connected through the first locking member 1531.

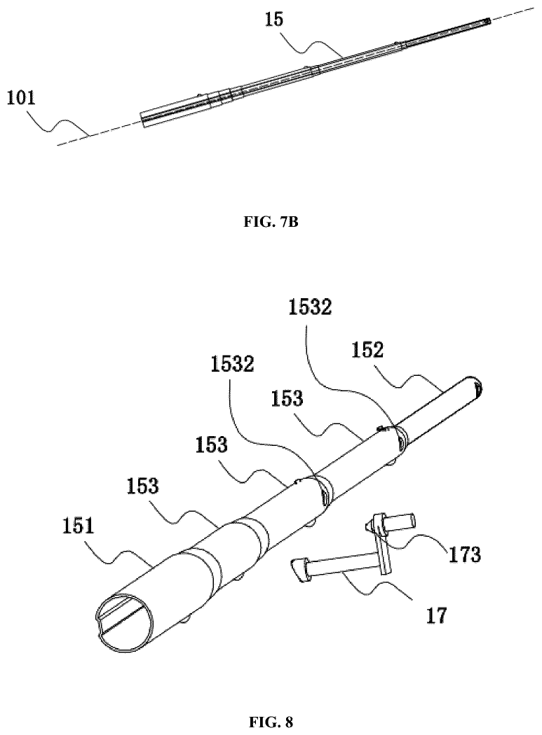

For example, as shown in FIG. 7A, when the adjustment device 15 has the first length in the direction of the first straight line 101, the second connecting rod 152 and the intermediate connecting rod 153 close to the second connecting rod 152 are relatively fixed under the action of the locking member. Referring to FIG. 7B, when the adjustment device 15 has the second length in the direction of the first straight line 101, all the locking members in the adjustment device 15 are located in the corresponding limiting holes. In this example, as shown in FIG. 3, when the adjustment device 15 has the second length in the direction of the first straight line 101, the first distance L between the grip center A of the handle 12 and the center B of the guide plate 131 is configured to be less than or equal to 1 meter.

Referring to FIGS. 1, 2, and 8, the chainsaw 100 further includes an adjustment switch 17 partially disposed in a groove 1241 formed by the left handle housing 124. The adjustment switch 17 is disposed on the handle 12. The adjustment switch 17 has a locking state and an unlocking state. For example, when the adjustment switch 17 is in the unlocking state, the handle 12 is movable relative to the rear part 112 of the body housing 11 along the direction of the first straight line 101. For example, the adjustment switch 17 includes a push rod 171 for the user to operate. When the user presses the push rod 171, the adjustment switch 17 is in the unlocking state; and when the user releases the push rod 171, the adjustment switch 17 is in the locking state. For example, the adjustment switch 17 further includes a return spring 172. When the user releases the push rod 171, the adjustment switch 17 returns to the locking state from the unlocking state under the action of the return spring 172.

For example, as shown in FIG. 8, the adjustment device 15 is provided with multiple locking holes 1532. When the adjustment switch 17 is in the locking state, a locking post 173 of the adjustment switch 17 is located in one of the multiple locking holes 1532 so that the handle 12 and the body housing 11 cannot move relative to each other. When the adjustment switch 17 is in the unlocking state, the locking post 173 of the adjustment switch 17 is disengaged from the locking hole 1532 so that the handle 12 and the body housing 11 are movable relatively in the direction of the first straight line 101. It is to be understood that many methods for implementing the adjustment switch exist.

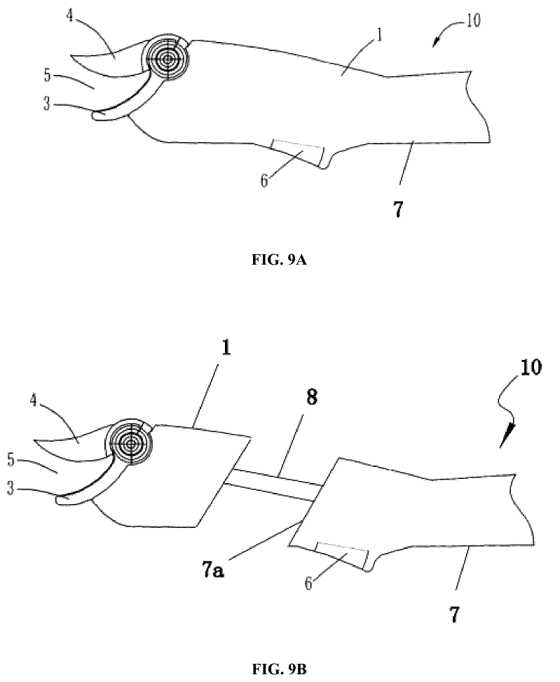

As a second example of the handheld power tool 10, as shown in FIGS. 9A and 9B, the handheld power tool 10 is, for example, electric scissors 10 generally configured to prune branches or forest trees. The electric scissors come in many shapes and types. The electric scissors 10 in this example include a body housing 1 and a motor (not shown in the figure) mounted in the body housing 1. The cutter part of a pruner 10 is formed by a fixed blade 3 and a movable blade 4. The fixed blade 3 is fixedly mounted relative to the body housing 1, and the movable blade 4 is connected to the motor through a power transmission device. A knife edge 5 is formed between the fixed blade 3 and the movable blade 4. A switch 6 is mounted on the body housing 1. To be suitable for different working places, the pruner 10 is powered by the battery pack mounted at the end of the handle 7. The pruner 10 further includes a handle 7 for the user to hold and an adjustment device 8.

For example, the adjustment device is disposed between the body housing 1 and the handle 7. The handle 7 is movable relative to the body housing 1 along the extension direction of the adjustment device 8. The adjustment device 8 is telescopic to a first state and a second state along the extension direction of the adjustment device 8. FIG. 9A shows a schematic view of the electric scissors 10 when the adjustment device 8 is in the first state. FIG. 9B shows a schematic view of the electric scissors 10 when the adjustment device 8 is in the second state. When the adjustment device 8 is in the first state, the distance between a front end surface 7a of the handle 7 and the rear part of the body housing 1 is the shortest. When the adjustment device is in the second state, the part of the adjustment device located between the front end surface of the handle and the rear part of the body housing has at least a first length and a second length, and the second length is greater than the first length. During the movement of the handle 7, the shortest distance between the front end surface 7a of the handle 7 and the rear end surface of the body housing 1 in the front and rear direction is greater than or equal to 0 and less than or equal to 0.03 meters. For example, the shortest distance between the front end surface 7a of the handle 7 and the rear end surface of the body housing 1 in the front and rear direction is greater than or equal to 0 and less than or equal to 0.02 meters. The shortest distance between the front end surface 7a of the handle 7 and the rear end surface of the body housing 1 in the front and rear direction is greater than or equal to 0 and less than or equal to 0.01 meters. In some examples, the handle 7 is formed with an accommodation space, and when the adjustment device 8 is in the first state, the adjustment device 8 can be completely disposed in the preceding accommodation space.

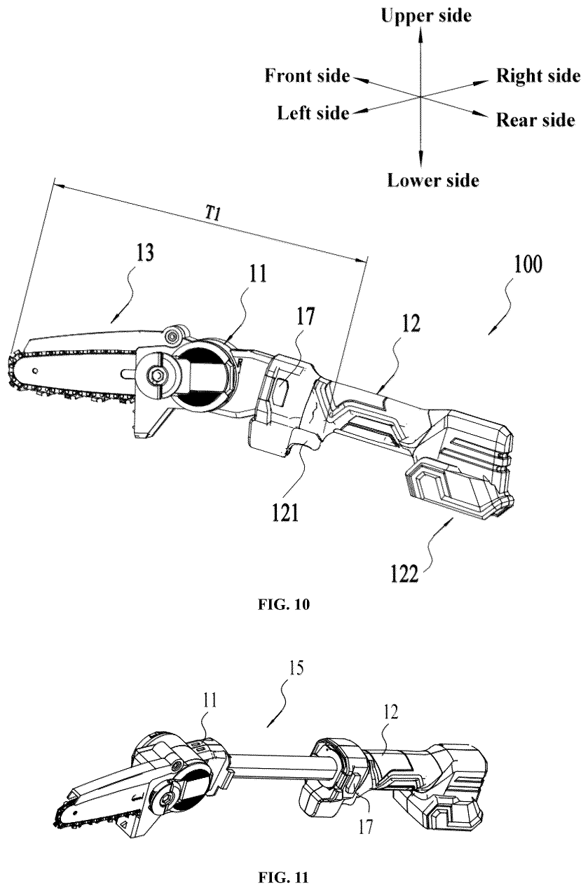

As a third example of the handheld power tool 10, referring to FIGS. 10 to 13, the handheld power tool 10 is, for example, a chainsaw 100. The chainsaw 100 includes a first connecting rod 151 and a second connecting rod 152. The first connecting rod 151 is connected to a handle 12, and the second connecting rod 152 is connected to the rear part of a body housing 11. In an example, both the first connecting rod 151 and the second connecting rod 152 are aluminum tubes.

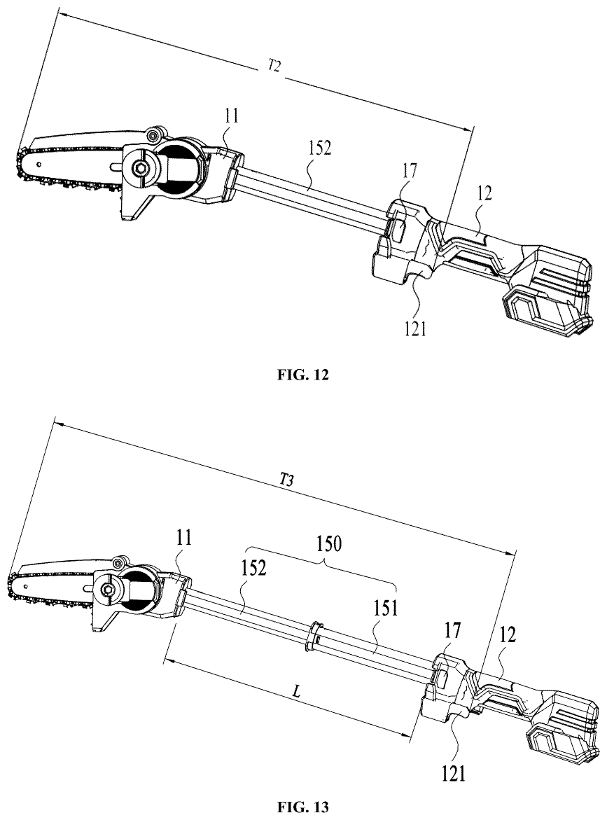

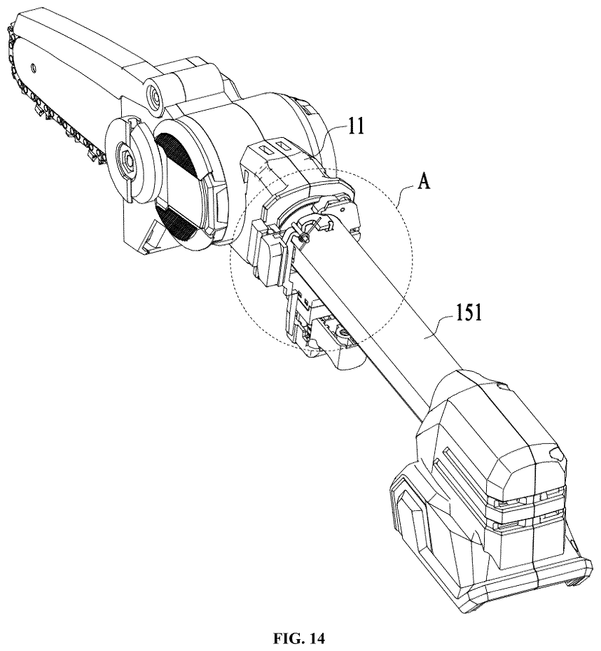

The adjustment device 15 has a first state and a second state so that the chainsaw 100 has a retracted state and an extended state. When the adjustment device 15 is in the first state, the chainsaw 100 is in the retracted state. As shown in FIG. 10, both the first connecting rod 151 and the second connecting rod 152 are retracted into the handle 12. When the adjustment device 15 is in the second state, the chainsaw 100 is in the extended state. In this example, the extended state is divided into two cases. In one case, as shown in FIGS. 11 and 12, the second connecting rod 152 extends out of the handle 12, and the first connecting rod 151 is located inside the handle 12. In the other case, as shown in FIG. 13, the first connecting rod 151 extends out of the handle 12, and the second connecting rod 152 extends out of the first connecting rod 151.

In this example, not only can the adjustment switch 17 lock the first connecting rod 151 and the second connecting rod 152, but also the adjustment switch 17 and the first switch 121 can be interlocked.

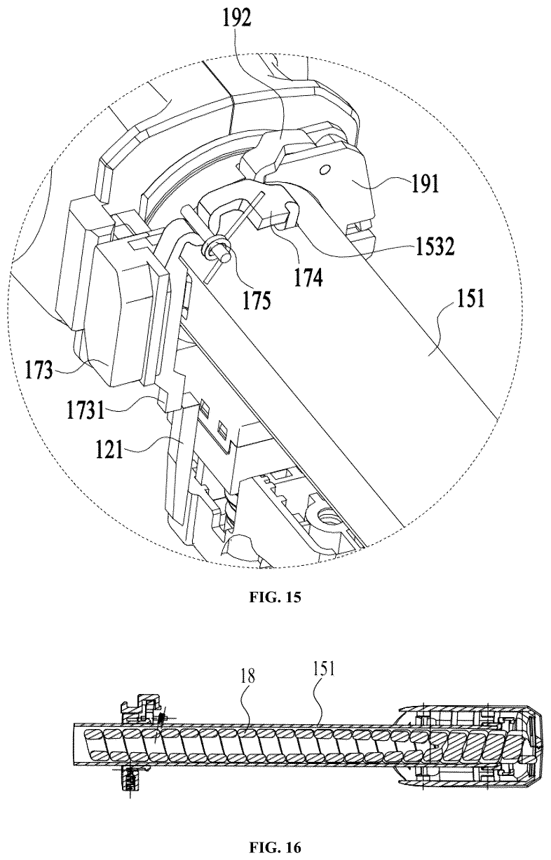

For example, as shown in FIGS. 14 and 15, the adjustment switch 17 includes a button 173 for the user to operate. When the user presses the button 173 to the right side of the chainsaw 100, the adjustment switch 17 is in the unlocking state; and when the user releases the button 173, the adjustment switch 17 is in the locking state. The adjustment switch 17 further includes a first seesaw 174 and a reset torsion spring 175. The first seesaw 174 rotates about a first rotary shaft, and the reset torsion spring 175 is sleeved on the first rotary shaft. When the user presses the button 173, the button 173 presses one end of the first seesaw 174 to lift the other end of the first seesaw 174; and when the user releases the button 173, under the action of the reset torsion spring 175, the button 173 and the first seesaw 174 are reset.

The adjustment device 15 is provided with a locking hole 1532, and the end of the first seesaw 174 can extend into the locking hole 1532 so that the adjustment device 15 is locked, and the handle 12 and the body housing 11 cannot move relative to each other. According to actual requirements, the first connecting rod 151 and the second connecting rod 152 are both provided with locking holes 1532, and when the chainsaw 100 is in a fully retracted state, one locking hole 1532 on the first connecting rod 151 is aligned with one locking hole 1532 on the second connecting rod 152 so that the first seesaw 174 can lock the first connecting rod 151 and the second connecting rod 152 at the same time.

A stop portion 1731 is disposed on the button 173. When the user presses the button 173, the stop portion 1731 is located on the movement path of the first switch 121 so that the first switch 121 cannot be pressed, and thus the first switch 121 is restricted from implementing a power-on function. For example, the stop portion 1731 is located on a side of the button 173 facing the first switch 121, and the first seesaw 174 is located on a side of the button 173 facing away from the first switch 121. Since when the adjustment switch 17 is in the unlocking state, the handle 12 is movable relative to the body housing 11 along the direction of the first straight line, to ensure safety, the power-on function of the first switch 121 is limited.

As shown in FIG. 15, when the adjustment switch 17 is in the locking state, the end of the first seesaw 174 extends out of the locking hole 1532, the relative positions of the handle 12 and the body housing 11 are fixed, and the first switch 121 can implement the power-on function. When the adjustment switch 17 is in the unlocking state, the first switch 121 is locked by the adjustment switch 17 so that the first switch 121 cannot be pressed, and thus the first switch 121 cannot implement the power-on function. For example, as shown in FIG. 16, the wire is inserted through the handle 12 and the adjustment device 15, and the wire connects the motor 14 to the power supply device. For example, the wire is a spring wire so that the wire can be lengthened and shortened as the adjustment device 15 is lengthened and shortened, and thus the power supply stability is not affected.

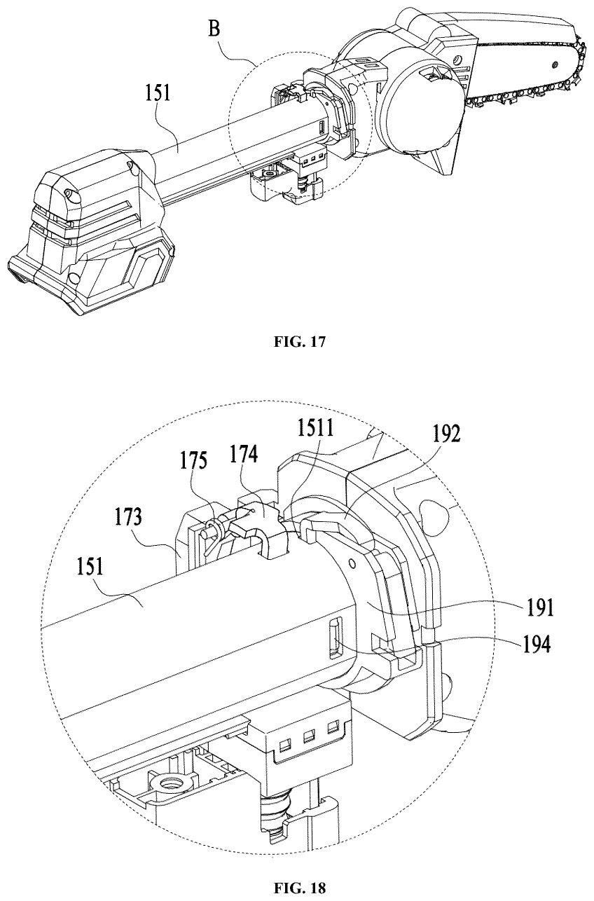

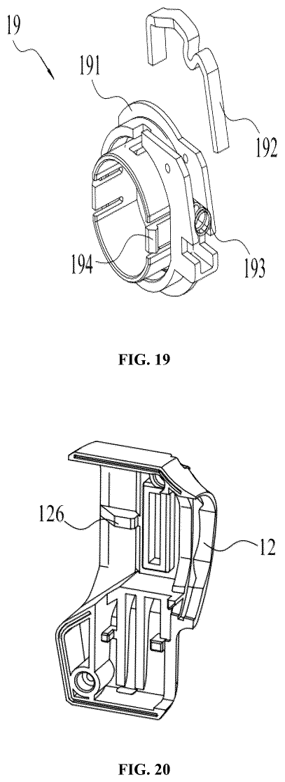

Referring to FIGS. 17 to 20, a locking assembly is disposed between the first connecting rod 151 and the second connecting rod 152. When both the first connecting rod 151 and the second connecting rod 152 extend out of the handle 12, the first connecting rod 151 and the second connecting rod 152 are locked by the locking assembly. When the second connecting rod 152 extends out of the handle 12 and the first connecting rod 151 retracts into the handle 12, the locking assembly provides resistance in the extension direction for the first connecting rod 151.

For example, the locking assembly includes a second seesaw 192 and a protective plate 191 disposed on the second connecting rod 152. The second seesaw 192 and the protective plate 191 are rotatably connected through a second rotary shaft. A resistance spring 193 is disposed on the protective plate 191 and sandwiched between the protective plate 191 and one end of the second seesaw 192. The first connecting rod 151 is provided with a limiting hole 1511, and one end of the second seesaw 192 facing away from the resistance spring can extend into the limiting hole 1511 so that the first connecting rod 151 and the second connecting rod 152 are locked.

A limiting block 126 is disposed on the inner wall of the handle 12. The limiting block 126 can abut against the second seesaw 192 and compress the resistance spring 193. When the second connecting rod 152 extends out of the handle 12 and the first connecting rod 151 retracts into the handle 12, the limiting block 126 abuts against one end of the second seesaw 192 and compresses the resistance spring 193 so that the resistance spring 193 provides resistance to prevent the first connecting rod 151 from sliding out of the handle 12. At this time, if the user needs to pull out the first connecting rod 151, the user needs to overcome the resistance of the resistance spring 193. The advantage of this setting is that the operating feel of the user is improved. When the user feels resistance when pulling out the second connecting rod 152, it can be considered that the second connecting rod 152 has been pulled out in place.

The protective plate 191 covers two sides of the second seesaw 192 to prevent the following: branches and the like are accidentally in contact with the second seesaw 192, causing the resistance spring 193 to be pressed down due to the accidental contact when the resistance spring 193 does not need to be compressed, resulting in safety hazards.

The protective plate 191 and the second connecting rod 152 are engaged through an elastic snap 194. During retraction, after the limiting block 126 abuts against the second seesaw 192, the protective plate 191 is fixed, the second connecting rod 152 continues retracting, and the external force applied by the user to the second connecting rod 152 overcomes the elastic force of the elastic snap 194.

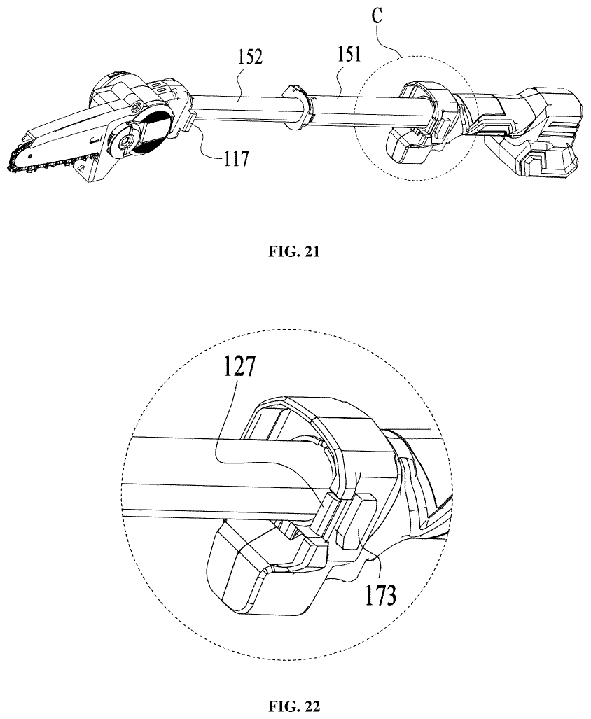

As shown in FIGS. 21 to 23, a clamping structure is further disposed between the handle 12 and the body housing 11. The clamping structure includes a clamping tooth 127 on the button 173 and a snap groove at the rear end of the body housing 11. For example, the body housing 11 is provided with a protrusion 117, and the snap groove is opened on the protrusion 117. When the user presses the button 173, the clamping tooth 127 is disengaged from the snap groove, and the body housing 11 can slide relative to the handle 12; and when both the first connecting rod 151 and the second connecting rod 152 retract and the user releases the button 173, the clamping tooth 127 and the snap groove are clamped so that the body housing 11 and the handle 12 are locked.

In the chainsaw 100 provided in this example, when the chainsaw 100 is in the fully retracted state, one locking hole 1532 on the first connecting rod 151 is aligned with one locking hole 1532 on the second connecting rod 152, and the end of the first seesaw 174 extends into the locking holes 1532 so that the first connecting rod 151 and the second connecting rod 152 are locked. At the same time, the clamping tooth 127 is clamped into the snap groove so that the body housing 11 and the handle 12 are locked.

When the chainsaw 100 needs to be unfolded, the user presses the button 173, and the button 173 presses one end of the first seesaw 174 to disengage the other end of the first seesaw 174 from the locking holes 1532. At this time, the handle 12 and the body housing 11 are movable along the direction of the first straight line 101. After the user applies a force to the body housing 11 to pull out the second connecting rod 152, the second connecting rod 152 extends out of the handle 12, and the first connecting rod 151 is located inside the handle 12. At this time, if the user releases the button 173, under the action of the reset torsion spring 175, the button 173 and the first seesaw 174 are reset, and the end of the first seesaw 174 extends into the locking hole 1532 of the second connecting rod 152 to lock the second connecting rod 152.

When the user presses the button 173 again, the button 173 presses one end of the first seesaw 174 to disengage the other end of the first seesaw 174 from the locking hole 1532 of the second connecting rod 152. At this time, the handle 12 and the body housing 11 are movable along the direction of the first straight line 101. At this time, the user needs to apply a force to the second connecting rod 152 and the first connecting rod 151 along the length direction of the second connecting rod 152 so that the second seesaw 192 is disengaged from the limiting block 126, and the first connecting rod 151 is pulled out. At this time, one end of the second seesaw 192 facing away from the resistance spring extends into the limiting hole 1511 so that the first connecting rod 151 and the second connecting rod 152 are locked stably.

When the first connecting rod 151 extends out of the handle 12, the chainsaw 100 is in a fully extended state. If the user releases the button 173, under the action of the reset torsion spring 175, the button 173 and the first seesaw 174 are reset, and the end of the first seesaw 174 extends into the locking hole 1532 of the first connecting rod 151 to lock the first connecting rod 151.

When the chainsaw 100 needs to be stored, the user presses the button 173, and the button 173 presses one end of the first seesaw 174 to disengage the other end of the first seesaw 174 from the locking hole 1532 of the first connecting rod 151. Since one end of the second seesaw 192 is still located in the limiting hole 1511, the first connecting rod 151 and the second connecting rod 152 are locked. The first connecting rod 151 retracts into the handle 12 first, and when the limiting block 126 is in contact with the second seesaw 192, the limiting block 126 abuts against one end of the second seesaw 192 to disengage the other end of the second seesaw 192 from the limiting hole 1511. At this time, the second connecting rod 152 is slidable relative to the first connecting rod 151, and the second connecting rod 152 retracts into the first connecting rod 151. The user releases the button 173. Under the action of the reset torsion spring 175, the button 173 and the first seesaw 174 are reset, the end of the first seesaw 174 extends into the locking hole 1532 of the second connecting rod 152, and at the same time, the clamping tooth 127 and the snap groove are engaged.

In conjunction with FIGS. 10, 12, and 13, the handheld power tool 10 includes the output assembly 13 connected to the body housing and configured to perform an output operation; the adjustment device is disposed between the body housing and the handle; the handle is movable relative to the body housing along the extension direction of the adjustment device; and the distance between the frontmost side of the power tool and the rearmost side of the first switch 121 is defined as the effective length of the power tool, the handheld power tool 10 includes at least a first effective length T1 and a second effective length T2, and the handheld power tool 10 can work normally at both the first effective length T1 and the second effective length T2. That is to say, the handheld power tool 10 has at least a first working state and a second working state. When the handheld power tool 10 is in the first working state, the handheld power tool 10 has the first effective length T1; and when the handheld power tool 10 is in the second working state, the handheld power tool 10 has the second effective length T2. The first effective length T1 is less than or equal to 60 cm, and the second effective length T2 is greater than the first effective length T1.

The effective length of the chainsaw refers to the distance between the frontmost side of the chain 132 and the rearmost side of the first switch 121. If the switch is the first switch 121 shown in the figure, the rearmost side of the switch is the rearmost side of the first switch 121. If the switch is a switch that is pushable forward and backward, the “rearmost side of the switch” in the effective length refers to the rearmost side of the switch when the switch is in the rearmost gear. That is to say, if the first switch 121 is a switch that is pushable forward and backward, the change in the position of the first switch 121 in the front and rear direction due to the turn-on of the switch is not included in the change in effective length.

For the power tool with a saw blade attachment such as a reciprocating saw and a jigsaw, the effective length refers to the distance between the frontmost housing of the power tool without the saw blade attachment and the rearmost side of the first switch 121. For the power tool with a chain such as a chainsaw, the effective length refers to the distance between the chain and the rearmost side of the first switch 121.

As shown in FIG. 12, in this example, the distance between the frontmost side of the chain 132 and the rearmost side of the first switch 121 is T2, and T2 is about between 50 cm and 70 cm. In this example, T2 is about 65 cm. Both the first connecting rod 151 and the second connecting rod 152 can completely enter the handle 12 when retracted, thereby not only ensuring the portability of the chainsaw 100 but also ensuring the retractability of the chainsaw 100. In some examples, T2 may be 58 cm, 60 cm, 62 cm, 68 cm, or the like.

In an example, T1 is greater than or equal to 25 cm and less than or equal to 50 cm. The power tool is moderately long and telescopic, so the power tool can adapt to a variety of working conditions.

In an example, the difference between the second effective length T2 and the first effective length T1 is greater than or equal to 5 cm. In an example, the difference between the second effective length T2 and the first effective length T1 is greater than or equal to 10 cm. In an example, the difference between the second effective length T2 and the first effective length T1 is greater than or equal to 15 cm. In an example, the difference between the second effective length T2 and the first effective length T1 is greater than or equal to 20 cm.

The power tool further includes the greatest third effective length T3, and the difference between the third effective length T3 and the second effective length T2 is greater than or equal to 10 cm.

The power tool further includes the coupling portion 122 configured to mount a battery pack, and the total weight of the power tool to which the battery pack is mounted is less than or equal to 6 kg. The whole machine is relatively light in weight, is portable in operation, and can adapt to a wide range of applications. In some examples, the total weight may be 5 kg or 4 kg. In the third example, the total weight is about 2.2 kg.

It is to be noted that the technical solutions involved in the present application can be applied to the following types of power tools: a nail gun, a trimming machine, a one-handed reciprocating saw, a blower, a pruner, a hedge trimmer, a mower, a one-handed circular saw, a cleaning brush, and the like. The power tools are telescopic and can adapt to a variety of work conditions and workspaces.

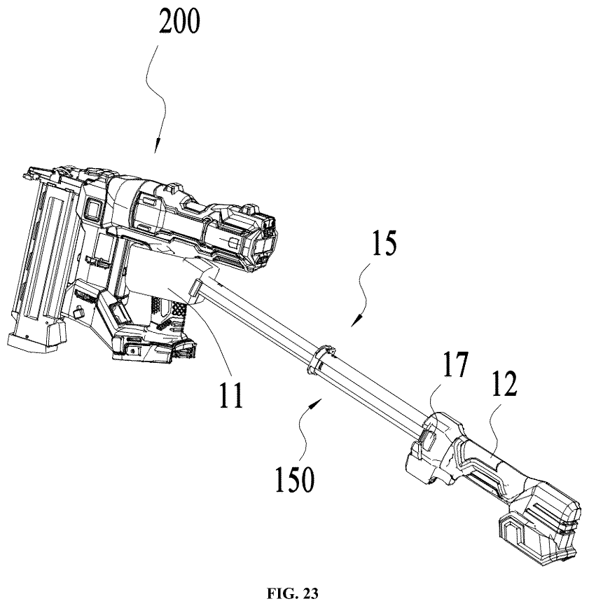

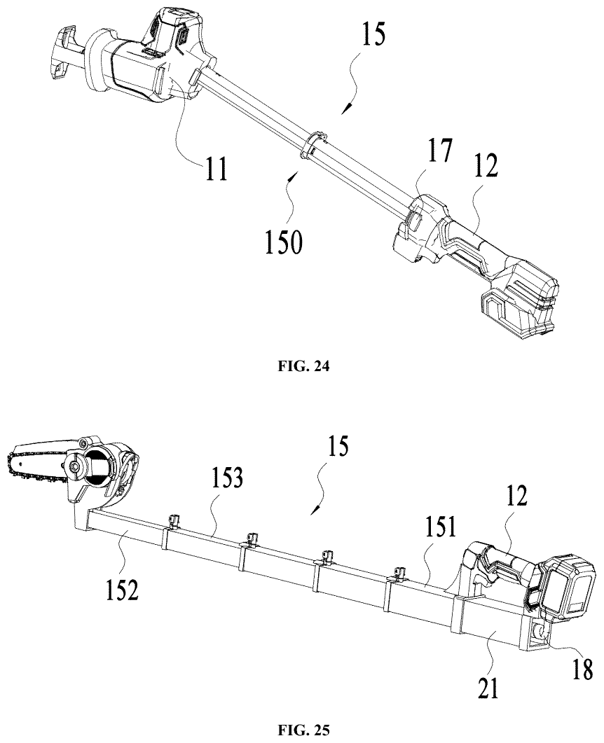

As a fourth example of the handheld power tool 10, referring to FIGS. 23 and 24, the adjustment device 15, the adjustment switch 17, the locking assembly, and the clamping structure provided in the third example above can be used in other handheld power tools 10, such as the nail gun shown in FIG. 23 and the reciprocating saw shown in FIG. 24. For example, FIG. 24 shows a one-handed mini reciprocating saw, which is also a small-sized reciprocating saw.

In FIG. 23, the adjustment switch 17 is disposed on the handle 12. It is to be noted that when the solution disclosed in example three is applied in the form of an extension rod attachment, the handle 12 of the extension rod attachment is further provided with the additional adjustment switch 17 that is different from the switch provided on the original power tool. The adjustment switch 17 is electrically connected to the body housing of the handheld power tool 10.

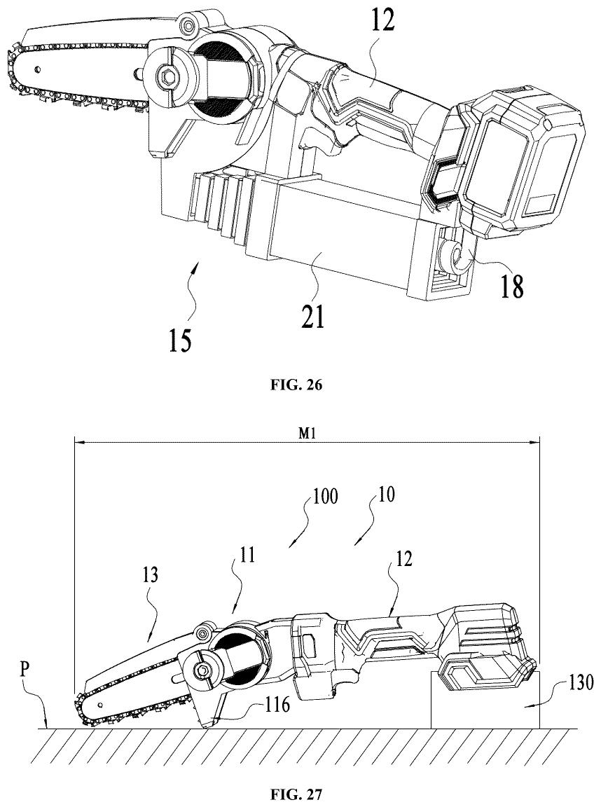

As a fifth example of the handheld power tool 10, referring to FIGS. 25 and 26, the chainsaw 100 further includes a housing disposed on a side of the handle 12 and connected to the handle 12, one end of the adjustment device 15 is located in the housing, and the other end of the adjustment device 15 is connected to the body housing 11.

The adjustment device 15 includes at least the first connecting rod 151, the second connecting rod 152, and at least one intermediate connecting rod 153. The first connecting rod 151 is connected to the housing, the second connecting rod 152 is connected to the body housing 11, and the intermediate connecting rod 153 is disposed between the first connecting rod 151 and the second connecting rod 152. For the connection manner of the first connecting rod 151, the second connecting rod 152, and the intermediate connecting rod 153, reference may be made to example one and example three, and the details are not repeated here.

A spring wire 18 is inserted through the housing and the adjustment device 15. One end of the spring wire 18 is connected to the motor, and the other end of the spring wire is connected to the power supply device.

In an example, T1 is greater than or equal to 10 cm and less than or equal to 40 cm. In this case, the length of the handheld power tool 10 from the grip part of the hand of the user to the frontmost side of the output assembly 13 for operation is smaller, that is to say, the volume of the tool is smaller. Therefore, when the solutions involved in the present application are adopted, the handheld power tool 10 is more compact and convenient, can be freely telescopic, and can satisfy the requirements of various working conditions.

It is to be noted that the technical solutions in the five examples described above can be adopted in conjunction with each other, and some repetitive features are not repeatedly described at the time of writing the present application.

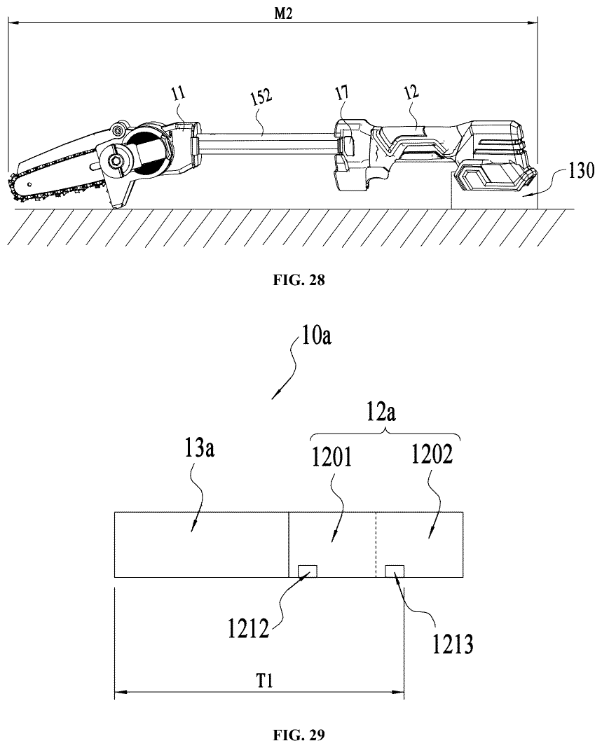

As shown in FIGS. 27 and 28, when the handheld power tool 10 or the chainsaw 100 is placed on a horizontal plane P, the body housing 11 has a protruding support housing 116 so that the chain 132 will not touch the horizontal plane P when the chainsaw 100 is placed on the horizontal plane. At the other end of the chainsaw 100, that is, on a side where a battery pack 130 is mounted, the battery pack 130 may touch the horizontal plane P. When the handheld power tool 10 or the chainsaw 100 is placed in this manner, the distance of the entire handheld power tool 10 or chainsaw 100 in the front and rear direction is defined as the total length of the handheld power tool 10 or chainsaw 100. The total length is adjustable, and the minimum value of the total length is less than 1.2 m.

The handheld power tool 10 has at least two working states, that is, the first working state and the second working state. When the handheld power tool 10 is in the first working state, the handheld power tool 10 has a first total length M1; and when the handheld power tool 10 is in the second working state, the handheld power tool has a second total length M2. The first total length M1 is less than or equal to 1.2 m, and the second total length M2 is greater than the first total length M1. In an example, the first total length M1 is less than or equal to 1 m. In an example, the first total length M1 is less than or equal to 0.8 m. In an example, the first total length M1 is less than or equal to 0.7 m. In an example, the first total length M1 is less than or equal to 0.6 m.

In an example, the first total length M1 is less than or equal to 1 m, and the first effective length T1 is less than or equal to 60 cm. In an example, the first total length M1 is less than or equal to 1 m, and the first effective length T1 is less than or equal to 50 cm. In an example, the difference between the second total length M2 and the first total length M1 is greater than or equal to 10 cm. In an example, the difference between the second total length M2 and the first total length M1 is greater than or equal to 20 cm.

It is to be noted that the minimum value of the total length M refers to the shortest total length when the adjustment device 15 of the handheld power tool 10 or chainsaw 100 retracts along the front and rear direction of the tool. The content in the example shown in FIG. 27 that is repeated in the examples shown in FIGS. 1 to 26 is not repeatedly described.

The following is a supplementary description of the first switch 121. The first switch 121 can at least control the starting and stopping of the motor. That is to say, the first switch 121 may have other functions, such as adjusting the rotational speed of the motor. At least one first switch 121 may be provided.

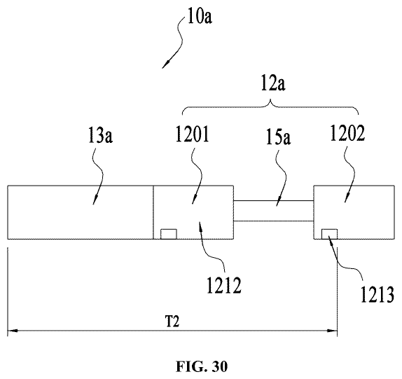

The examples shown in FIGS. 29 and 30 are described below. As shown in FIG. 29, a handheld power tool 10a includes an output assembly 13a and a handle 12a for the user to hold. The handheld power tool 10a has at least two switches that can control the starting and stopping of the motor, that is, a second switch 1212 and a first switch 1213. The second switch 1212 and the first switch 1213 are spaced apart from each other on the handle 12a. The handle 12a may be divided into a first handle portion 1201 and a second handle portion 1202. The first handle portion 1201 is closer to the output assembly 13a than the second handle portion 1202. The second switch 1212 is disposed on the first handle portion 1201, and the first switch 1213 is disposed on the second handle portion 1202.

An adjustment device 15a is further disposed in the handle 12a. When the handheld power tool 10a is extended from the retracted state shown in FIG. 29 to the extended state shown in FIG. 30, the adjustment device 15a increases the distance between the first handle portion 1201 and the second handle portion 1202. In an example, the adjustment device 15a may be a telescopic rod assembly similar to or different from the preceding structure. In the retracted state shown in FIG. 29, the user may hold the hand on the first handle portion 1201 and control the starting and stopping of the motor by operating the second switch 1212. In the extended state shown in FIG. 30, the user may hold the hand on the second handle portion 1202 and control the starting and stopping of the motor by operating the first switch 1213.

The distance between the rearmost side of the first switch 1213 and the frontmost side of the handheld power tool 10a is adjustable. The distance between the frontmost side of the handheld power tool 10a and the rearmost side of the first switch is defined as the effective length of the handheld power tool 10a. The handheld power tool 10a includes at least the first effective length T1 and the second effective length T2. The handheld power tool 10a has at least two working states, that is, the first working state and the second working state. When the handheld power tool 10a is in the first working state, the handheld power tool 10a has the first effective length T1; and when the handheld power tool 10a is in the second working state, the handheld power tool 10a has the second effective length T2. The first effective length T1 is less than or equal to 1 m, and the second effective length T2 is greater than the first effective length T1. It is to be noted that the definition of the first effective length T1 and the second effective length T2 in this case is consistent with the preceding description, and the details are not repeated here.

For the example disclosed in FIGS. 29 and 30, one usage situation may be that in the retracted state of FIG. 29, the user uses the second switch 1212; and in the extended state of FIG. 30, the user uses the first switch 1213. It is to be noted that although only one of the first switch 1213 and the second switch 1212 can be activated at a moment and used for the user to control the starting and stopping of the motor, both the first switch 1213 and the second switch 1212 can be used for controlling the starting and stopping of the motor.

As shown in FIGS. 6 and 13, the adjustment device 15 includes a telescopic rod assembly 150. The adjustment device 15 can enable the handheld power tool 10 to have at least two working states, that is, the first working state and the second working state. In some examples, the adjustment device 15 may not include the telescopic rod assembly 150, and other structures may be used to adjust the overall length of the handheld power tool 10.

In addition, one-handed saws are common in the field of power tools. A one-handed saw is generally a sawing power tool that is operable by the user with just one hand. According to different purposes and working conditions, the one-handed saws may generally be divided into a one-handed chainsaw, a mini chainsaw, a one-handed reciprocating saw, a mini reciprocating saw, a one-handed electric circular saw, a mini electric circular saw, and the like. Two hands are generally required to hold the pole saw. The one-handed chainsaw and the mini chainsaw tend to be shorter in length than the pole saw and are generally configured to cut items at close range. In the technical solutions involved in the present application, the chainsaw can be used in a variety of working conditions, the limit on the distance between the object to be cut and the user is smaller, and the chainsaw may be long or short, flexible in operation, and suitable for a variety of working conditions.

With continued reference to FIGS. 27 and 28, the present application discloses a one-handed saw. The one-handed saw includes a motor accommodated in a body housing; a handle for a user to hold; and an output assembly for performing an output operation. When the one-handed saw is placed on a horizontal plane, the maximum distance of the one-handed saw along the direction parallel to the horizontal plane is defined as the total length of the one-handed saw, and the total length is adjustable.

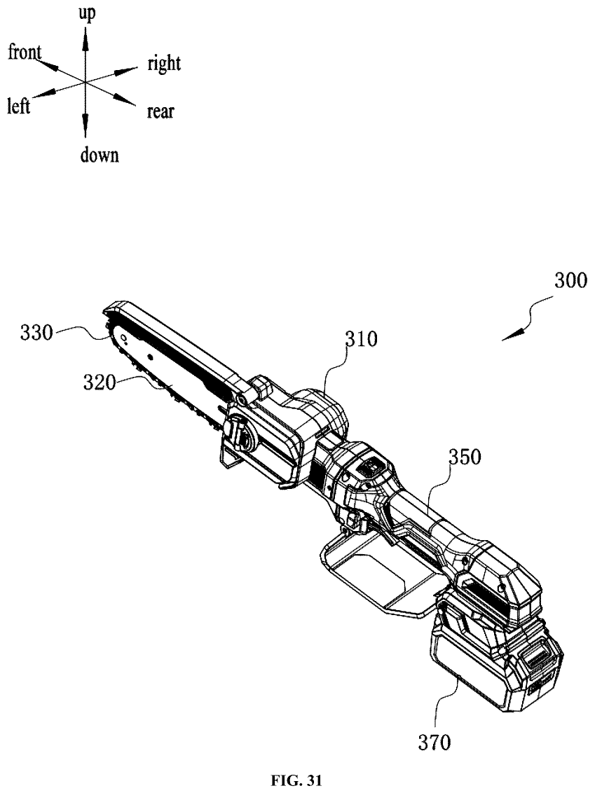

FIG. 31 shows a chainsaw 300 as an example in the present application. As shown in FIGS. 31 to 33, the chainsaw 300 includes a body housing 310, a guide plate 320, a chain 330, and an electric motor 340. At the same time, FIG. 31 defines the directions of the front side, the rear side, the upper side, the lower side, the left side, and the right side in the present application.

The body housing 310 has a front part 3111, a rear part 3112, and an intermediate part 3113 between the front part 3111 and the rear part 3112, and an accommodation space is formed in the body housing 310. The guide plate 320 extends forward from the front part 3111 of the body housing 310, part of the rear end of the guide plate 320 is located inside the front part 3111 of the body housing 310, and most of the rest of the guide plate 320 extends out of the front part 3111 of the body housing 310. The guide plate 320 supports the chain 330 around the outer periphery of the guide plate 320, and the chain 330 is a functional piece of the chainsaw 300. In some examples, the chainsaw 300 further includes a protective cover 3121 detachably connected to the front part 3111 of the body housing 310. The protective cover 3121 accommodates part of the guide plate 320 and the chain 330 and protects the chain 330 and the user.

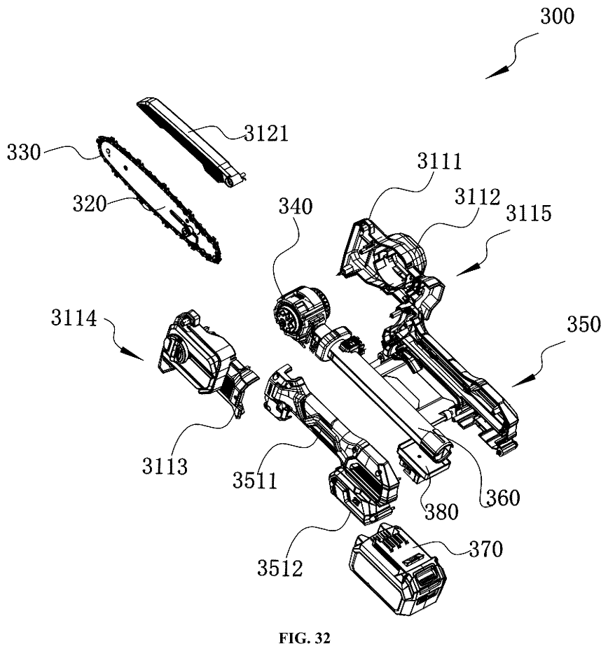

The electric motor 340 is accommodated in the intermediate part 3113 of the body housing 310. As shown in FIG. 32, in this example, the body housing 310 may include a left body housing 3114 and a right body housing 3115 that can be joined together, and the electric motor 340 may be accommodated in the intermediate part 3113 of the right body housing. After the motor shaft of the electric motor 340 rotates, the chain 330 may be driven directly or indirectly through a transmission assembly so that the chain 330 moves around the guide plate 320 to perform the cutting operation. The motor axis may be basically perpendicular to a first plane 3202 where the guide plate 320 is located. In some examples, the electric motor 340 is a brushless direct current (DC) electric motor 340 so that the dimension of the electric motor 340 is reduced while the performance of the electric motor 340 is maintained.

The body length L3 is defined as the distance between the frontmost side of the front part 3111 of the body housing 310 and the rearmost side of the rear part 3112 of the body housing 310. In some examples, to take into account both the cutting performance and structural arrangement of the telescopic chainsaw, the ratio of the output power of the chainsaw 300 to the body length L3 may be greater than or equal to 1.5 W/mm and less than or equal to 3.5 W/mm. Specifically, the output power of the chainsaw may be the output power of the electric motor 340, the rated power of the electric motor 340, or the power of an output shaft driving the chain 330 to move. In other examples, the ratio of the output power of the chainsaw 300 to the body length L3 may be greater than or equal to 2 W/mm and less than or equal to 3 W/mm.

As shown in FIGS. 31 to 33, the chainsaw 300 further includes a handle 350, an adjustment device 360, and a power supply device 370.

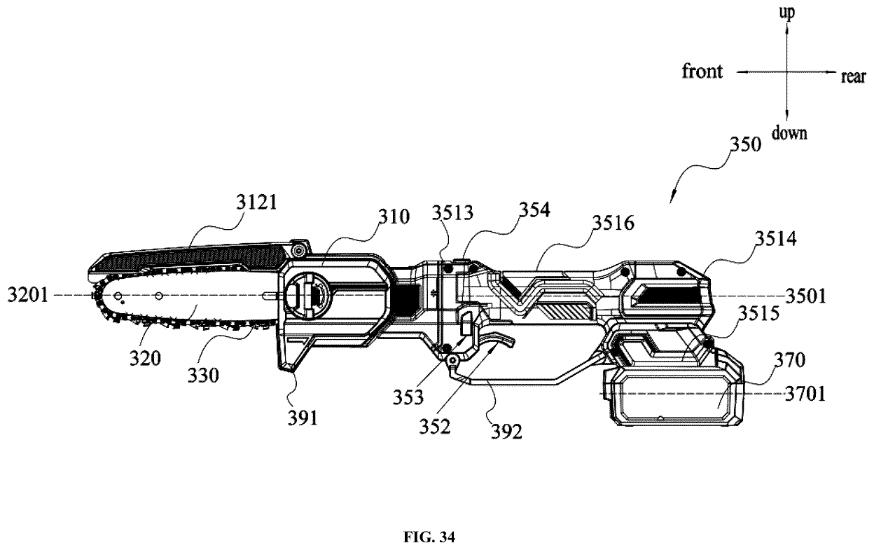

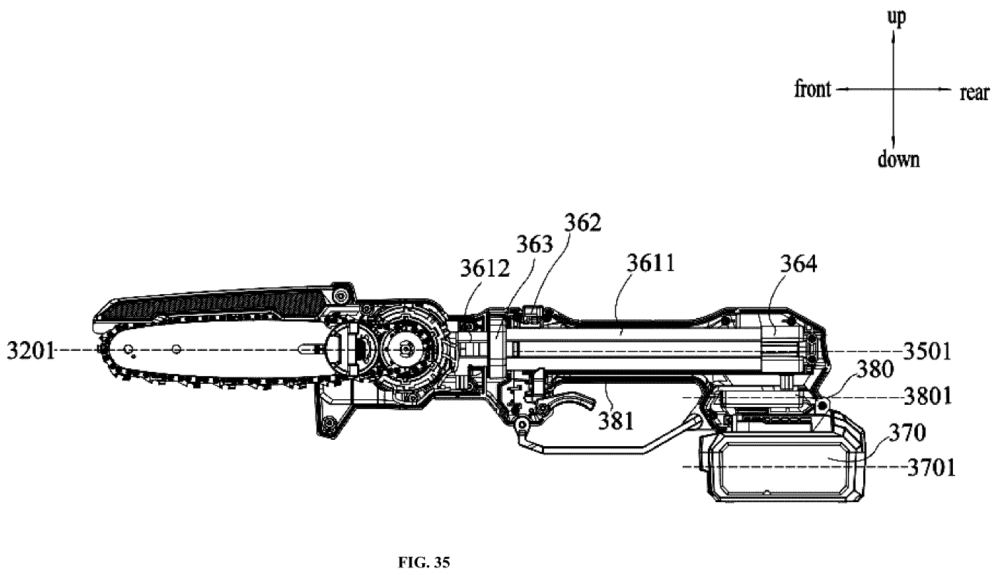

The handle 350 is used for the user to hold and has an upper part 3511 and a lower part 3512, and an accommodation space is formed in the handle 350. The front end of the upper part 3511 of the handle forms a front end 3513 of the handle, the rear end of the upper part 3511 of the handle is connected to the lower part 3512 of the handle, and the rear end of the upper part 3511 of the handle and the rear end of the lower part 3512 of the handle together form a rear end 3514 of the handle. The handle 350 is located on the rear side of the body housing 310. The front end 3513 of the handle is close to the rear part 3112 of the body housing 310, and the rear end 3514 of the handle is away from the body housing 310. A handle grip 3516 actually held by the user is between the front end 3513 and the rear end 3514 of the handle. The cross section of the handle grip 3516 may be quasi-circular or quasi-rectangular, and the centerline 3501 of the handle passes through the handle grip 3516. As shown in FIGS. 34 and 35, the centerline 3501 of the handle 350 is basically parallel to the centerline 3201 of the guide plate 320 to provide a more stable center of gravity of the telescopic chainsaw. In this example, the centerline 3501 of the handle and the centerline 3201 of the guide plate may coincide and are the same straight line to further stabilize the center of gravity. In other cases, the centerline 3501 of the handle may be parallel to the centerline 3201 of the guide plate, and the centerline 3501 of the handle is located above or below the centerline 3201 of the guide plate.

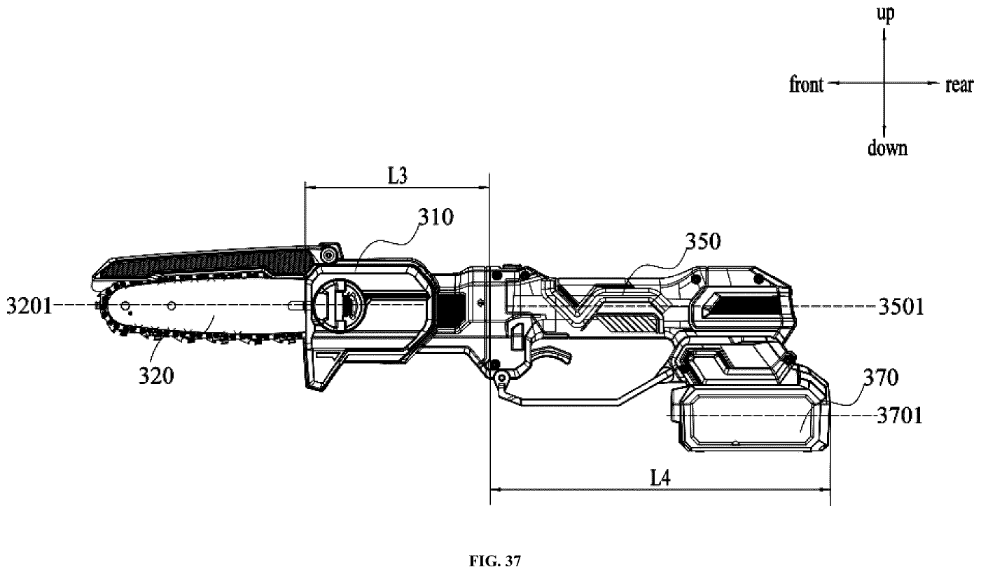

As shown in FIG. 37, the body length L3 is defined as the distance between the frontmost side of the front part 3111 of the body housing 310 and the rearmost side of the rear part 3112 of the body housing 310, and the handle length L4 is defined as the distance between the front end surface 3513 of the handle and the rear end surface 3514 of the handle. In some examples, to optimize the center of gravity of the telescopic chainsaw and improve the operating feel of the telescopic chainsaw, the ratio of the body length L3 to the handle length L4 may be greater than or equal to 0.3 and less than or equal to 0.8. In other examples, the ratio of the body length L3 to the handle length L4 may be greater than or equal to 0.4 and less than or equal to 0.7.

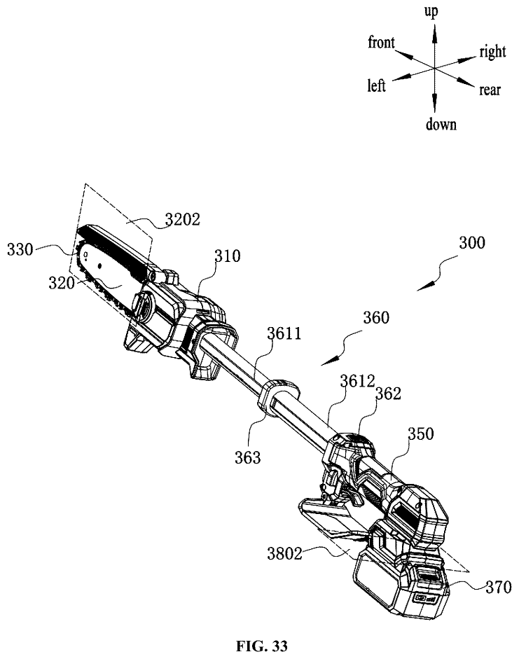

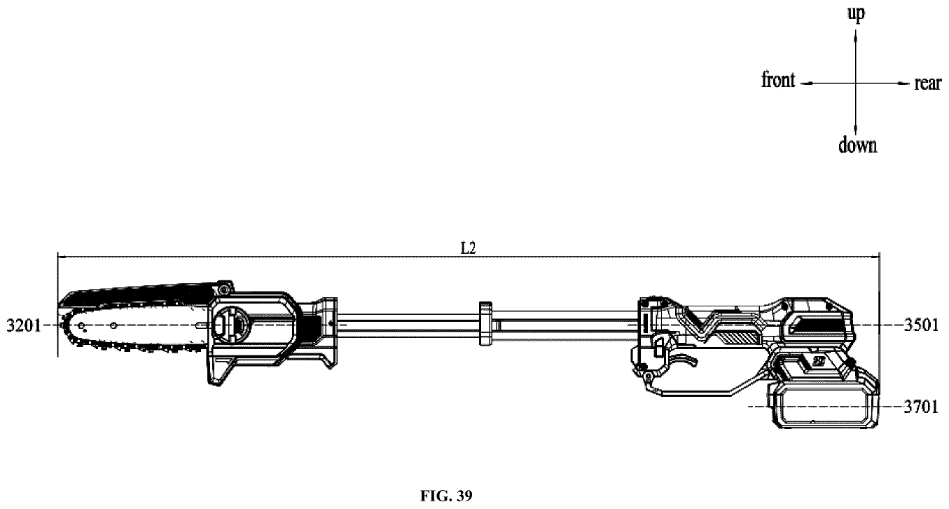

Through the change in the length of the adjustment device 360, the adjustment device 360 causes the body housing 310 and the handle 350 to move relative to each other in the telescopic direction of the adjustment device 360. The adjustment device 360 has the retracted state and the extended state and may further include one or more semi-extended states between the retracted state and the extended state. The length of the chainsaw 300 in the retracted state is shorter, the length of the chainsaw 300 in the extended state or the semi-extended state is longer, and the length of the chainsaw 300 in the extended state is greater than the length of the chainsaw 300 in the semi-extended state. The adjustment device 360 may be implemented by multiple connecting rods sleeved in sequence and a locking assembly, and the specific structure is described in detail below. As shown in FIGS. 31, 34, and 35, when the adjustment device 360 is in the retracted state, the front end surface 3513 of the handle abuts against the rear part 3112 of the body housing 310; and the adjustment device 360 may be entirely accommodated in the handle 350, or the adjustment device 360 may be partially accommodated in the handle 350 and partially accommodated in the body housing 310. As shown in FIGS. 33 and 39, when the adjustment device 360 is in the extended state, the front end surface 3513 of the handle is separated from the rear part 3112 of the body housing 310, the adjustment device 360 may be located between the handle 350 and the body housing 310, part of the rear end of the adjustment device 360 may be located in the handle 350, part of the front end of the adjustment device 360 may be located in the rear part 3112 of the body housing 310, and most of the rest of the adjustment device 360 extends out of the handle 350 and the body housing 310.

A first switch 352 for the user to operate is disposed on the handle 350. The first switch 352 may be located near the front end surface 3513 of the handle. The first switch 352 may be used for controlling the starting or stopping of the electric motor 340 and may also be used for controlling the rotational speed of the electric motor 340. In this example, the first switch may be a trigger switch 352. The trigger switch 352 may be located near the front end 3513 of the handle and may rotate around the shaft relative to the handle 350. When the chainsaw 300 is equipped with the power supply device 370, the torque from the first switch 352 to the frontmost side of the chain 330 is less than or equal to 2.6 N·m. In other cases, the first switch 352 may be a toggle switch 52 that is toggled along the front and rear direction or the left and right direction.

The power supply device 370 can supply power to at least the electric motor 340 so that the electric motor 340 can drive the chain 330 to move around the guide plate 320. In this example, the power supply device 370 is a battery pack 370, and the power supply voltage of the battery pack 370 is greater than or equal to 12 V and less than or equal to 60 V. However, the power supply device 370 is not limited to the battery pack, and the chainsaw 300 may be powered in other forms. In some cases, power supply may be achieved using AC power in conjunction with related circuits such as the transformer circuit, the rectifier circuit, and the voltage regulator circuit or the power adapter. As shown in FIGS. 34 and 35, the power supply device 370 is located below the centerline 3501 of the handle 350 and is connected to the rear end 3514 of the handle. In this example, the lower part 3512 of the handle is formed with or connected to a coupling portion 3515. A battery pack 70 is detachably connected to the coupling portion 3515 along the direction of a second straight line 701. The battery pack 70 may be inserted into the coupling portion 3515 or pulled out from the coupling portion 3515 along the direction of the second straight line 701. In this example, the second straight line 701 is basically parallel to the centerline 3501 of the handle. For example, the plane where the battery pack 70 is located may be perpendicular to the first plane 3202 where the guide plate 320 is located. In other cases, the second straight line 701 may be at a certain angle to the centerline 3501 of the handle.

In some examples, the total weight of the chainsaw 300 to which the power supply device 370 is not mounted is less than or equal to 2.5 kg. In other examples, the total weight of the chainsaw 300 to which the power supply device 370 is not mounted is less than or equal to 2 kg.

The chainsaw 300 further includes a circuit board assembly 380 for controlling the power supply status of the power supply device 370 and the operating status of the electric motor 340. As shown in FIGS. 34 and 35, the circuit board assembly 380 is disposed in the lower part 3512 of the handle, located below the centerline 3501 of the handle, and supported by the handle 350. The circuit board centerline 3801 of the circuit board assembly 380 may be parallel to the centerline 3501 of the handle. In some examples, a second plane 3802 where the circuit board assembly 380 is located may be entirely below the centerline 3501 of the handle and may be perpendicular to the first plane 3202 where the guide plate 320 is located.

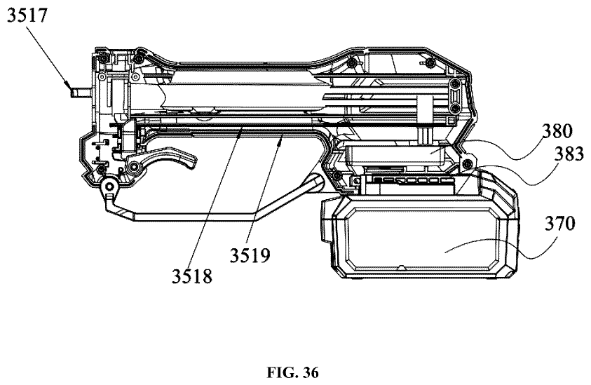

The chainsaw 300 further includes a fixed wire 381 and a movable wire 382. The fixed wire 381 may electrically connect the circuit board assembly 380 to the first switch 352, and the position of the fixed wire 381 may be fixed and may be a conventional circuit line. As shown in FIG. 36, the fixed wire 381 may start from the circuit board assembly 380 in the lower part 3512 of the handle, pass through the handle 350 along a wire groove 3519 on the lower inner wall of the upper part 3511 of the handle, and reach the first switch 352 near the front end 3513 of the handle. The movable wire 382 may electrically connect the power supply device 370 to the electric motor 340. Since the adjustment device 360 with varying lengths exists between the power supply device 370 and the electric motor 340, the movable wire 382 may be a spring wire 382 that is telescopic with the adjustment device 360 without affecting the power supply stability. As shown in FIG. 36, the spring wire 382 is inserted through the rear end 3514 of the handle and the adjustment device 360. In some examples, when the adjustment device 360 is in the retracted state, the spring wire 382 may be in a pre-stretched state so that the service life of the spring wire 382 can be extended.

The lower part 3512 of the handle is further provided with a heat dissipation port 383 on the housing close to the circuit board assembly 380. The heat dissipation port 383 can physically dissipate heat for the circuit board assembly 380. In other cases, the chainsaw 300 further includes a fan, the fan may be mounted on the motor shaft and rotate with the motor shaft, the adjustment device 360 is designed to be in a highly airtight state, the heat dissipation port 383 may be an airflow inlet, and the cooling airflow generated by the fan may flow through the circuit board assembly 380, the adjustment device 360, and the electric motor 340 so that the heat dissipation performance of the telescopic chainsaw can be improved.

A second switch 353 for the user to operate is further disposed on the handle. The second switch 353 can lock the electric motor 340 to remain in the starting state or the stopping state. In some examples, the second switch 353 may be disposed on the upper side of the first switch 352 along the up and down direction, and the second switch 353 in the handle 350 may be located between the first switch 352 and a telescopic rod assembly 361; however, the second switch 353 located between the first switch 352 and the telescopic rod assembly 361 causes the outer diameter D of the handle 350 to increase, affecting the user's feeling of holding the handle 350. As shown in FIG. 36, in this example, the second switch 353 may be disposed on the front side of the first switch 352 along the front and rear direction, and the second switch 353 in the handle 350 may be located on the front side of the first switch 352, on the lower side of the telescopic rod assembly 361, and near the front end 3513 of the handle, thereby not causing an increase in the outer diameter of the handle 350 and improving the user's feeling of holding the handle 350. In other examples, the second switch 353 further has an inclined surface at the position of the thumb of the user when the user holds the chainsaw 300 so that the user can rest the thumb on the second switch 353 comfortably.

The chainsaw 300 further includes a support assembly 390 for enabling the chainsaw 300 to which the power supply device 370 is mounted or not to stand horizontally. That is, when the chainsaw 300 is placed horizontally, the support assembly 390 can support the chainsaw 300 and enable the chainsaw 300 to keep balance and stability. At this time, the centerline 3201 of the guide plate of the chainsaw 300 remains basically parallel to the horizontal plane or at an unchanged included angle to the horizontal plane. In some examples, the support assembly 390 may include at least a first support member 391 and a second support member 392, where the first support member 391 is in front and the second support member 392 is in the rear. The support provided by the first support member 391 or the second support member 392 when the chainsaw 300 stands horizontally may be any one of point support, line support, or surface support or any combination thereof. In some examples, the chainsaw 300 to which the power supply device 370 is mounted or not is supported by the first support member 391 and the second support member 392 to stand horizontally. In other examples, the chainsaw 300 to which the power supply device 370 is not mounted is supported by the first support member 391 and the second support member 392 to stand horizontally, and the chainsaw 300 to which the power supply device 370 is mounted is supported by the first support member 391 and the power supply device 370 mounted on the rear part of the chainsaw 300 to stand horizontally. As shown in FIGS. 33 and 34, in some examples, the first support member 391 is connected to the body housing 310 or is a part of the body housing 310. For example, the first support member 391 may be a triangular support shown in the figure. The second support member 392 is connected to the handle 350. For example, the second support member 392 may be a rectangular handguard shown in the figure. When the chainsaw 300 to which the power supply device 370 is not mounted is placed on a horizontal surface, the chainsaw 300 is supported by the bottom end of the first support member 391 and the front edge of the second support member 392. When the chainsaw 300 to which the power supply device 370 is mounted is placed on a horizontal surface, the chainsaw 300 is supported by the bottom end of the first support member 391 and the bottom surface of the power supply device 370.

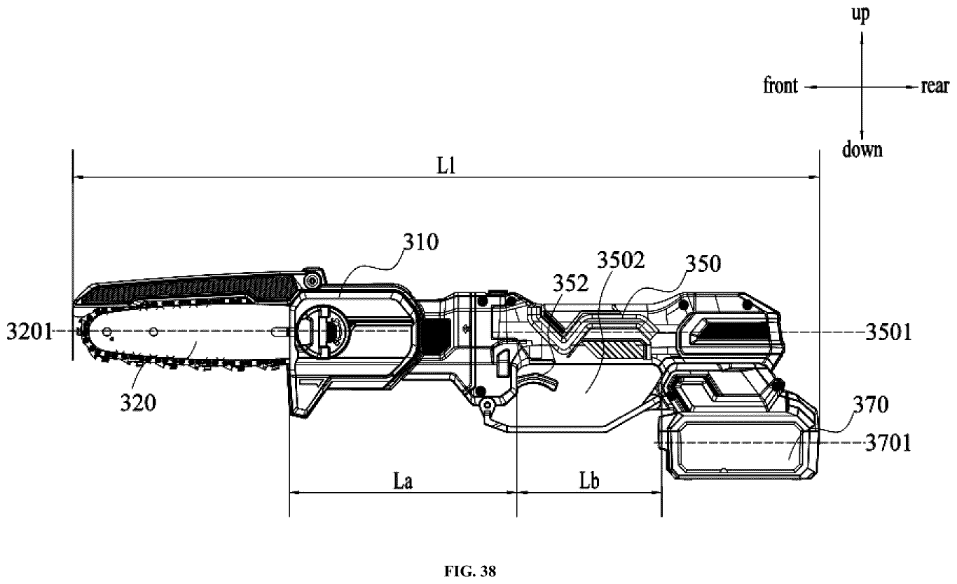

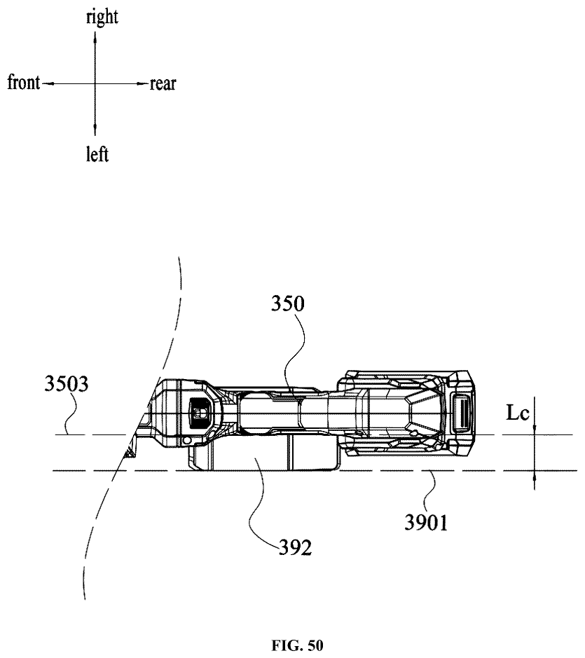

In some examples, the chainsaw 300 further includes a protective part below the grip 3516 of the handle 350, the front and rear ends of the protective part are connected to the handle 350, and the protective part and the handle 350 form a through hole 3502 for the user to pass through so that in unexpected cases, for example, the chain 330 falls off the guide plate 320 or the chain 330 is broken, the path of the chain 330 hitting the human hand is blocked, thereby protecting the user and preventing the unsupported chain 330 from cutting the human hand. In some examples, the protective part and the handle 350 are integrally formed. As shown in FIGS. 38 and 50, in this example, the protective part is a handle baffle, that is, a rectangular handguard 92 that has the functions of a support member and a protective part. In some examples, the distance Lb between the frontmost side of the first switch 352 and the rear edge of the through hole 3502 is greater than or equal to 100 mm. The frontmost side of the first switch 352 is the frontmost end of the intersecting line of the first switch 352 and the handle 350 in the projection along the left and right direction, and the rear edge of the through hole 3502 is the rearmost end that the fingers can reach in the through hole 3502 when the user holds the handle 350 with four fingers. In some examples, in the projection along the up and down direction, the maximum value of the distance Lc between the outer edge 3901 of a protective part 392 on the same side as the guide plate 320 and the outer edge 3503 of the handle 350 on the same side as the guide plate 320 in the left and right direction is greater than or equal to 30 mm. Specifically, the outer edge 3503 of the handle 350 on the same side as the guide plate 320 may be the outer edge 3503 of the grip 3516 of the handle 350.

In some examples, the distance La between the rearmost side of the chain 330 exposed outside the body housing 310 and the frontmost side of the first switch 352 in the front and rear direction at least in some states during the telescopic process of the adjustment device 360 is greater than or equal to 125 mm. In some examples, it is not excluded that La is less than 125 mm in some states. The rearmost side of the chain 330 exposed outside the body housing 310 is the rearmost end of the intersecting line of the chain 330 and the body housing 310 in the projection along the left and right direction.

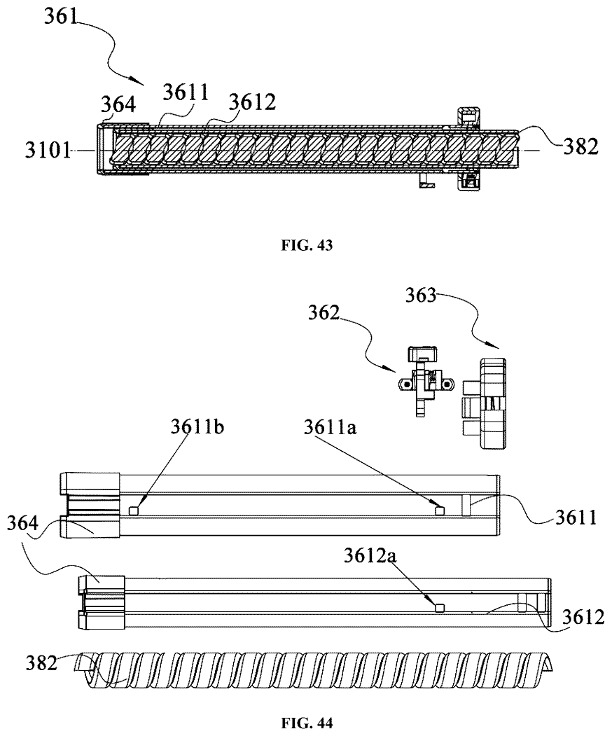

FIGS. 42 to 47 show the adjustment device 360 in the chainsaw 300 shown in FIGS. 31 and 33. The adjustment device 360 includes the telescopic rod assembly 361, where the telescopic rod assembly 361 is telescopic to at least a first state or a second state along the direction of a first straight line 3101. The first straight line 3101 is basically parallel to the centerline 3201 of the guide plate, that is, the first straight line 3101 is basically parallel to the centerline 3201 of the guide plate and the centerline 3501 of the handle. The telescopic rod assembly 361 is telescopic along the direction of the centerline 3201 of the guide plate or the centerline 3501 of the handle. In some examples, the first straight line 3101, the centerline 3201 of the guide plate, and the centerline 3501 of the handle coincide and are the same straight line.

As shown in FIGS. 31, 34, 35, and 38, the telescopic rod assembly 361 is in the first state, the adjustment device 360 is in the retracted state, the length of the chainsaw 300 at this time is defined as the first length L1 of the chainsaw 300, and the first length L1 is the minimum length of the telescopic chainsaw 300. As shown in FIGS. 33 and 39, the telescopic rod assembly 361 is in the second state, the adjustment device 360 is in the extended state, the length of the chainsaw 300 at this time is defined as the second length L2 of the chainsaw 300, and the second length L2 is the maximum length of the telescopic chainsaw 300. The telescopic rod assembly 361 is in other intermediate states between the first state and the second state, and the adjustment device 360 is in the semi-extended state. At this time, the length of the chainsaw 300 is between the first length L1 and the second length L2.

In some examples, to take into account both the telescopic function and the good center of gravity, the ratio of the second length L2 to the first length L1 of the chainsaw 300 may be greater than or equal to 1.4 and less than or equal to 2.8. In other examples, the ratio of the second length L2 to the first length L1 of the chainsaw 300 may be greater than or equal to 1.6 and less than or equal to 2.6. In other examples, the first length L1 of the chainsaw 300 is less than or equal to 550 mm, and the second length L2 of the chainsaw 300 is greater than or equal to 800 mm.

As shown in FIGS. 31, 34, and 35, when the telescopic rod assembly 361 is in the first state, the telescopic rod assembly 361 is retracted and accommodated in the handle 350. Viewed from top to bottom at the rear end 3514 of the handle, the housing of the upper part 3511 of the handle, the telescopic rod assembly 361, the housing of the lower part 3512 of the handle, and the power supply device 370 exist in sequence. The projection of the power supply device 370 and the projection of the telescopic rod assembly 361 on a projection plane perpendicular to the first plane 3202 where the guide plate 320 is located at least partially coincide. In some examples, viewed from top to bottom at the rear end 3514 of the handle, the housing of the upper part 3511 of the handle, the telescopic rod assembly 361, the circuit board assembly 380, the housing of the lower part 3512 of the handle, and the power supply device 370 exist in sequence. The projection of the circuit board assembly 380 and the projection of the telescopic rod assembly 361 on the projection plane perpendicular to the first plane 3202 where the guide plate 320 is located at least partially coincide.

In this example, when the telescopic rod assembly 361 is in the first state, the center of gravity of the chainsaw 300 to which the power supply device 370 is mounted is located at the handle grip 3516, which is at the purlicue in the axial direction of the handle when the user holds the handle, and the distance between the center of gravity of the chainsaw 300 and the centerline 3501 of the handle in the radial direction of the handle is less than or equal to 10 mm.

As shown in FIGS. 33 and 39, when the telescopic rod assembly 361 is in the second state, the telescopic rod assembly 361 extends out of the handle 350. Viewed from top to bottom at the rear end 3514 of the handle, the housing of the upper part 3511 of the handle, the housing of the lower part 3512 of the handle, and the power supply device 370 exist in sequence, or the housing of the upper part 3511 of the handle, part of the rear end of the telescopic rod assembly 361, the housing of the lower part 3512 of the handle, and the power supply device 370 exist in sequence. In some examples, viewed from top to bottom at the rear end 3514 of the handle, the housing of the upper part 3511 of the handle, the circuit board assembly 380, the housing of the lower part 3512 of the handle, and the power supply device 370 exist in sequence, or the housing of the upper part 3511 of the handle, part of the rear end of the telescopic rod assembly 361, the circuit board assembly 380, the housing of the lower part 3512 of the handle, and the power supply device 370 exist in sequence.

In this example, when the telescopic rod assembly 361 is in the second state, the center of gravity of the chainsaw 300 to which the power supply device 370 is mounted is located between the center of the handle 350 and the center of the guide plate 320.

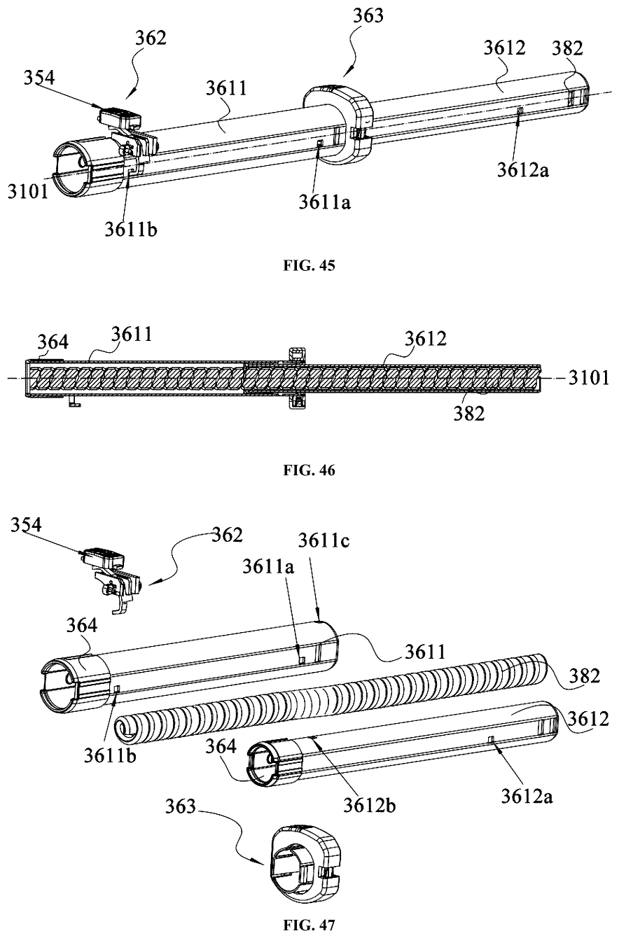

As shown in FIGS. 42 and 45, the telescopic rod assembly 361 may be formed by multiple connecting rods sleeved in sequence. The telescopic rod assembly 361 includes at least a first connecting rod 3611 and a second connecting rod 3612. The first connecting rod 3611 is closer to the handle 350 when the adjustment device 360 is in the extended state and is slidably connected to the handle 350. The second connecting rod 3612 is closer to the body housing 310 when the adjustment device 360 is in the extended state, and the front end of the second connecting rod 3612 is fixedly connected to the rear part of the body housing 310. In some examples, the first connecting rod 3611 and the second connecting rod 3612 may be made of aluminum alloys, magnesium alloys, or carbon fiber materials to improve the operating feeling of the telescopic chainsaw 300 without affecting the performance of the telescopic chainsaw 300.

In some examples, the first connecting rod 3611 and the second connecting rod 3612 may be flat tubes or square tubes, thereby enhancing the anti-rotation capability of the telescopic rod assembly 361, keeping the stability of the first connecting rod 3611 and the second connecting rod 3612 in the handle 350, and prevent the rotation of the first connecting rod 3611 and the second connecting rod 3612.

In some examples, as shown in FIGS. 36, 44, and 47, a bushing 364 is disposed at the rear end of the first connecting rod 3611, and the bushing 364 is clamped with the rear end 3514 of the handle so that the first connecting rod 3611 remains stable in the handle 350; guide ribs 3518 parallel to the centerline 3501 of the handle are disposed on the inner wall of the handle 350, and the bushing 364 at the rear end of the first connecting rod 3611 and/or the outer wall of the first connecting rod 3611 may mate with the guide ribs 3518 so that the first connecting rod 3611 is telescopic along the direction parallel to the centerline 3501 of the handle, and the stability of the first connecting rod 3611 during the telescopic process is ensured; the bushing 364 may abut against the housing at the front end 3513 of the handle when the telescopic rod assembly 361 is in the second state, thereby preventing the first connecting rod 3611 from being disengaged from the handle 350. In other examples, a bushing is disposed at the rear end of the second connecting rod 3612, and the bushing is clamped with the inner wall of the first connecting rod 3611 so that the second connecting rod 3612 remains stable in the first connecting rod 3611; and when the telescopic rod assembly 361 is in the second state, the bushing abuts against a second locking assembly 363 described below, thereby preventing the second connecting rod 3612 from being disengaged from the first connecting rod 3611.

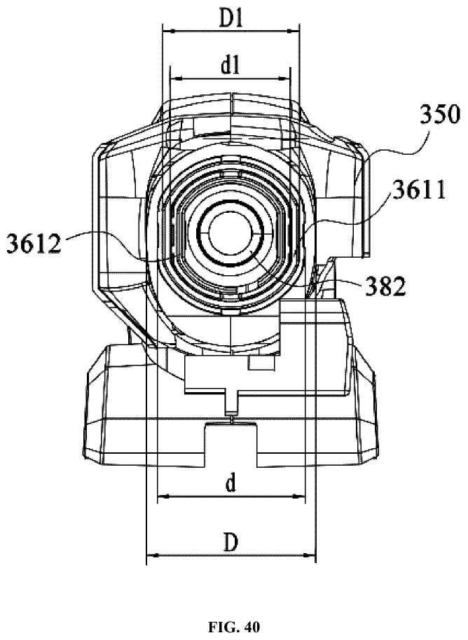

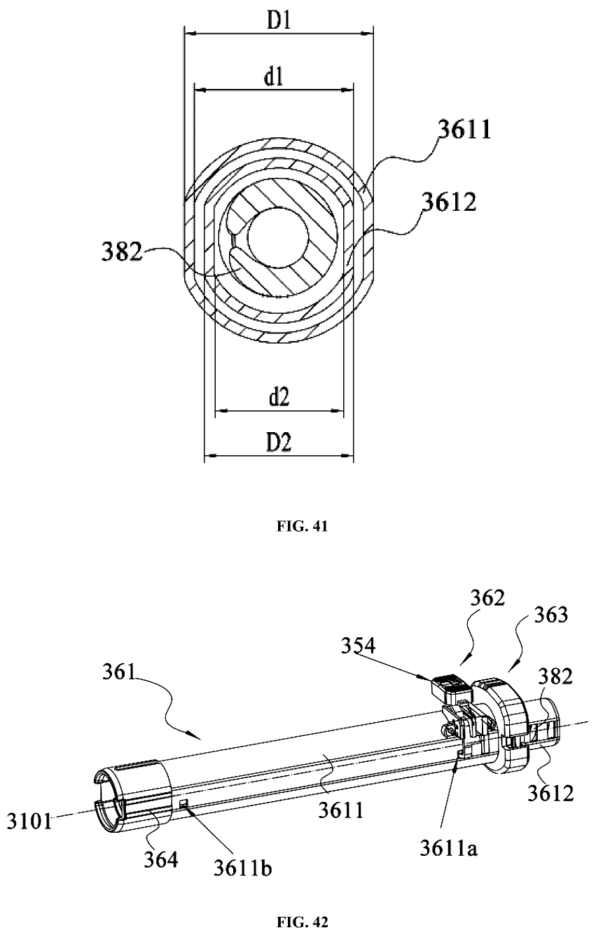

As shown in FIGS. 40 and 41, the outer diameter D1 of the first connecting rod 3611 is less than the inner diameter d of the handle, and the outer diameter D2 of the second connecting rod 3612 is less than the inner diameter d1 of the first connecting rod 3611. The following mainly describes the case where the telescopic rod assembly 361 includes the first connecting rod 3611 and the second connecting rod 3612. In other cases, the telescopic rod assembly 361 may include the first connecting rod 3611, the second connecting rod 3612, and at least one intermediate connecting rod. When the adjustment device 360 is in the extended state, the inner diameter of the connecting rod closer to the handle 350 in the front and rear direction is greater than the outer diameter of the connecting rod closer to the rear part 3112 of the body housing 310.

As shown in FIGS. 40 and 41, in some examples, to improve the operating feel of the telescopic chainsaw 300 and reduce the handle diameter, the ratio of the outer diameter D of the handle 350 to the outer diameter D1 of the first connecting rod 3611 may be less than or equal to 1.5, less than or equal to 1.4, or less than or equal to 1.3. In other examples, to improve the operating feel of the telescopic chainsaw 300, the ratio of the outer diameter D1 of the first connecting rod 3611 to the outer diameter D2 of the second connecting rod 3612 may be less than or equal to 1.5, less than or equal to 1.4, or less than or equal to 1.3. In other examples, to improve the operating feel of the telescopic chainsaw 300, the outer diameter D of the handle 350 is greater than or equal to 35 mm and less than or equal to 40 mm, and the outer diameter D1 of the first connecting rod 3611 is greater than or equal to 25 mm and less than or equal to 30 mm.

The adjustment device 360 further includes a first locking assembly 362 and a second locking assembly 363. The first locking assembly 362 is used for locking the handle 350, the first connecting rod 3611, the second connecting rod 3612, and the body housing 310 when the telescopic rod assembly 361 is in the first state so that in the first state, the first connecting rod 3611 and the second connecting rod 3612 remains in the state in which the first connecting rod 3611 and the second connecting rod 3612 are retracted and accommodated in the handle 350 and the front end 3513 of the handle closely abuts against the rear part 3112 of the body housing 310. The first locking assembly 362 is further used for locking the handle 350 and the first connecting rod 3611 when the telescopic rod assembly 361 is in the second state so that in the second state, the first connecting rod 3611 remains extended out of the front end 3513 of the handle. The second locking assembly 363 is used for locking the first connecting rod 3611 and the second connecting rod 3612 when the telescopic rod assembly 361 is in the second state so that in the second state, the second connecting rod 3612 remains extended out of the front end 3513 of the handle.

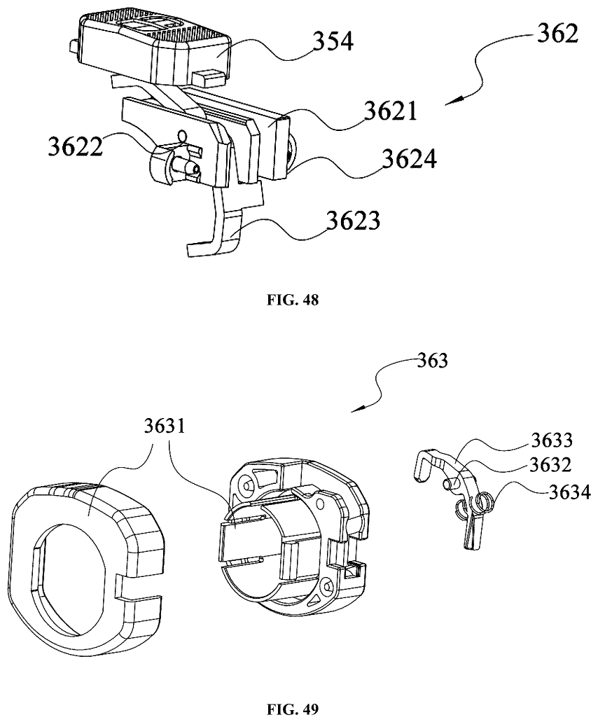

As shown in FIGS. 44, 47, and 48, in some examples, the first locking assembly 362 is connected to the inner wall of the handle 350. In this example, the first locking assembly 362 includes a first protective plate 3621 fixedly connected to the inner wall of the handle 350, a first seesaw 3623 rotatably connected to the first protective plate 3621 through a first rotary shaft 3622, and a reset torsion spring 3624 sleeved on the first rotary shaft 3622 and connected to the first seesaw 3623. The front end of the first connecting rod 3611 is provided with a first locking hole 3611a, and the front end of the second connecting rod 3612 is provided with a second locking hole 3612a. When the telescopic rod assembly 361 is in the first state, the first locking hole 3611a is aligned with the second locking hole 3612a, and one end of the first seesaw 3623 is inserted through the first locking hole 3611a and the second locking hole 3612a so that the positions of the first connecting rod 3611 and the second connecting rod 3612 are locked. Further, the rear end of the first connecting rod 3611 is provided with a third locking hole 3611b. When the telescopic rod assembly 361 is in the second state, one end of the first seesaw 3623 is inserted into the third locking hole 3611b so that the position of the first connecting rod 3611 is locked. In some examples, the first seesaw 3623 points to the center of the cross section of the handle grip 3516 when inserted into the locking hole.

As shown in FIGS. 44, 47, and 49, in some examples, the second locking assembly 363 is connected to the outer wall of the first connecting rod 3611. In this example, the second locking assembly 363 includes a second protective plate 3631 fixedly connected to the outer wall of the first connecting rod 3611, a second seesaw 3633 rotatably connected to the second protective plate 3631 through a second rotary shaft 3632, and a resistance spring 3634 sandwiched between the second protective plate 3631 and the second seesaw 3633. Further, the front end of the first connecting rod 3611 is provided with a fifth locking hole 3611c, and the rear end of the second connecting rod 3612 is provided with a fourth locking hole 3612b. When the telescopic rod assembly 361 is in the second state, one end of the second seesaw 3633 is inserted through the fourth locking hole 3612b and the fifth locking hole 3611c so that the positions of the first connecting rod 3611 and the second connecting rod 3612 are locked. In some examples, the second seesaw 3633 points to the center of the cross section of the handle grip 3516 when inserted into the locking hole. In some examples, the second protective plate 3631 may be annular and form a closed space on the outer wall of the first connecting rod 3611. The closed space accommodates the second seesaw 3633, the resistance spring 3634, and the like, thereby achieving a dust-proof effect and avoiding interference from branch debris during the cutting operation.

To avoid mutual interference between the first locking assembly 362 and the second locking assembly 363, the third straight line where the first locking hole 3611a, the second locking hole 3612a, and the third locking hole 3611b are located does not coincide with the fourth straight line where the fourth locking hole 3612b and the fifth locking hole 3611c are located. For example, the first locking hole 3611a, the second locking hole 3612a, and the third locking hole 3611b may be disposed on the left inner wall or the right inner wall of the first connecting rod 3611 and the second connecting rod 3612, and the fourth locking hole 3612b and the fifth locking hole 3611c may be disposed on the upper inner wall or the lower inner wall of the first connecting rod 3611 and the second connecting rod 3612, and vice versa.

In some examples, the first seesaw 3623 and the second seesaw 3633 may be square seesaws, and the corresponding locking holes are square locking holes so that the locking between the seesaws and the locking holes is more stable.

An adjustment switch 354 for the user to operate is disposed on the handle 350. The adjustment switch 354 may be disposed at the front end 3513 of the handle and near the handle grip 3516. The adjustment switch 354 is used for enabling or disabling the first locking assembly 362. Specifically, the adjustment switch 354 may include a button 354. When the button 354 is triggered, the pressure is applied to the non-insertion end of the first seesaw 3623 so that the first seesaw 3623 rotates around the shaft, and the insertion end of the first seesaw 3623 is disengaged from the locking hole.

As shown in FIG. 36, a limiting block 3517 is disposed on the inner wall of the handle 350. The limiting block 3517 may be disposed near the front end surface 3513 of the handle to enable or disable the second locking assembly 363. Specifically, when the limiting block 3517 is triggered, the limiting block 3517 may abut against the second seesaw 3633 and compress the resistance spring 3634 so that the second seesaw 3633 rotates around the shaft, and the insertion end of the second seesaw 3633 is disengaged from the locking hole.

The following first describes the extension process of the chainsaw 300 when the telescopic rod assembly 361 changes from the first state to the second state.

It is assumed that the telescopic rod assembly 361 is currently in the first state, and the insertion end of the first seesaw 3623 is inserted through the first locking hole 3611a and the second locking hole 3612a. When the user presses the button 54 to apply pressure to the non-insertion end of the first seesaw 3623, the first seesaw 3623 rotates around the first rotary shaft 3622, and the insertion end of the first seesaw 3623 is disengaged from the first locking hole 3611a and the second locking hole 3612a. If the limiting block 3517 is set in a triggered state when the telescopic rod assembly 361 is in the first state, that is, the limiting block 3517 in the first state abuts against the second seesaw 3633 and compresses the resistance spring 3634, and the insertion end of the second seesaw 3633 is not inserted into the fifth locking hole 3611c, then after the insertion end of the first seesaw 3623 is disengaged from the first locking hole 3611a and the second locking hole 3612a, the user can directly pull out the first connecting rod 3611 and the second connecting rod 3612, and whether the connecting rod extends out of the handle first is the first connecting rod 3611 or the second connecting rod 3612 is determined by the friction between the handle and the first connecting rod 3611 and the friction between the first connecting rod 3611 and the second connecting rod 3612.

When the first connecting rod and the second connecting rod extend out of the handle in sequence, the second seesaw 3633 abuts against the limiting block 3517 or the outer wall of the second connecting rod 3612 and compresses the resistance spring 3634, and the second seesaw 3633 remains uninserted into the fifth locking hole 3611c or inserted into the fifth locking hole 3611c but not into the fourth locking hole 3612b until the first connecting rod 3611 and the second connecting rod 3612 fully extend out of the handle 350; the second seesaw 3633 moves to the fourth locking hole 3612b and then is driven by the resistance spring 3634 to be inserted through the fourth locking hole 3612b and the fifth locking hole 3611c; and the first seesaw 3623 moves to the third locking hole 3611b and then is driven by the reset torsion spring 3624 to be inserted through the third locking hole 3611b, and the telescopic rod assembly 361 reaches the second state.

If the limiting block 3517 is set in a non-triggered state when the telescopic rod assembly 361 is in the first state, that is, the limiting block 3517 in the first state does not abut against the second seesaw 3633 or compress the resistance spring 3634, and the insertion end of the second seesaw 3633 is inserted into the fifth locking hole 3611c, then after the insertion end of the first seesaw 3623 is disengaged from the first locking hole 3611a and the second locking hole 3612a, the user can pull out the first connecting rod 3611 or the second connecting rod 3612.

In the case where the first connecting rod 3611 is pulled out first, the force applied by the user causes the limiting block 3517 to be triggered, the insertion end of the second seesaw 3633 is first disengaged from the fifth locking hole 3611c, the first connecting rod 3611 extends out of the handle, the second seesaw 3633 abuts against the outer wall of the second connecting rod 3612 and compresses the resistance spring 3634, and the second seesaw 3633 remains inserted into the fifth locking hole 3611c but not into the fourth locking hole 3612b until the first connecting rod 3611 and the second connecting rod 3612 fully extend out of the handle 350; the second seesaw 3633 moves to the fourth locking hole 3612b and then is driven by the resistance spring 3634 to be inserted through the fourth locking hole 3612b and the fifth locking hole 3611c; and the first seesaw 3623 moves to the third locking hole 3611b and then is driven by the reset torsion spring 3624 to be inserted through the third locking hole 3611b, and the telescopic rod assembly 361 reaches the second state.

In the case where the second connecting rod 3612 is pulled out first, the limiting block 3517 limits the extension of the first connecting rod 3611, and the second seesaw 3633 remains inserted into the fifth locking hole 3611c but not into the fourth locking hole 3612b until the second seesaw 3633 moves to the fourth locking hole 3612b and then is inserted through the fourth locking hole 3612b and the fifth locking hole 3611c; before the first seesaw 3623 is inserted into the first locking hole 3611a and the telescopic rod assembly 361 can reach the second state, a third state is reached in which the second connecting rod 3612 extends out of the handle 350 and the first connecting rod 3611 is retracted and accommodated in the handle 350, where the third state is the semi-extended state of the adjustment device 360; and then the user may pull out the first connecting rod 3611. For the subsequent specific process of reaching the second state, reference may be made to the relevant description above, and the details are not repeated here.

The following describes the retraction process of the chainsaw 300 when the telescopic rod assembly 361 changes from the second state to the first state.

It is assumed that the telescopic rod assembly 361 is currently in the second state, the insertion end of the first seesaw 3623 is inserted into the third locking hole 3611b, and the insertion end of the second seesaw 3633 is inserted through the fourth locking hole 3612b and the fifth locking hole 3611c. After the user presses the button 354 to apply pressure to the non-insertion end of the first seesaw 3623, the first seesaw 3623 rotates around the shaft, the insertion end of the first seesaw 3623 is disengaged from the third locking hole 3611b, and the first connecting rod 3611 can first retract into the handle 350 until the first seesaw 3623 moves to the first locking hole 3611a; and then the limiting block 3517 on the inner wall of the handle 350 enters the triggered state, and the limiting block 3517 abuts against the second seesaw 3633 and compresses the resistance spring 3634 so that the insertion end of the second seesaw 3633 is disengaged from the fourth locking hole 3612b and the fifth locking hole 3611c, and the second connecting rod 3612 can retract into the handle 350 until the first seesaw 3623 moves to the second locking hole 3612a and is inserted through the first locking hole 3611a and the second locking hole 3612a. In this manner, the telescopic rod assembly 361 reaches the first state.

In some examples, the adjustment device 360 may further include a greater number of locking assemblies in other forms, the telescopic rod assembly 361 may further include an intermediate connecting rod, and the connecting rods may be provided with a greater number of locking holes. In this manner, the locking assemblies mate with the telescopic rod assembly so that the stepless adjustment of the adjustment device 360 is achieved, and the length of the adjustment device 360 can be locked at any length value within a length range during the adjustment process.

What is claimed is:

1. A handheld power tool, comprising:
a motor;
a handle for a user to hold;
a first switch disposed on the handle and configured to at least control starting and stopping of the motor;
an output assembly configured to perform an output operation; and
an adjustment device comprising a telescopic rod assembly, wherein a length of the adjustment device changes so that the handheld power tool has at least a first working state and a second working state;
wherein a distance between a frontmost side of the handheld power tool and a rearmost side of the first switch is an effective length of the handheld power tool, when the handheld power tool is in the first working state, the handheld power tool has a first effective length (T1), when the handheld power tool is in the second working state, the handheld power tool has a second effective length (T2), the first effective length (T1) is less than or equal to 1 m, and the second effective length (T2) is greater than the first effective length (T1).

2. The handheld power tool of claim 1, wherein a difference between the second effective length (T2) and the first effective length (T1) is greater than or equal to 10 cm.

3. The handheld power tool of claim 1, wherein a difference between the second effective length (T2) and the first effective length (T1) is greater than or equal to 20 cm.

4. The handheld power tool of claim 1, wherein the handheld power tool has a third effective length (T3), the third effective length (T3) is greater than the second effective length (T2), and a difference between the third effective length (T3) and the second effective length (T2) is greater than or equal to 10 cm.

5. The handheld power tool of claim 1, further comprising a coupling portion configured to mount a battery pack, wherein a total weight of the handheld power tool to which the battery pack is mounted is less than or equal to 6 kg.

6. The handheld power tool of claim 1, wherein the adjustment device is telescopic to a first state and a second state along a front and rear direction of the handheld power tool.

7. The handheld power tool of claim 1, further comprising an adjustment switch having a stop portion, wherein at least a part of the adjustment switch is disposed on the handle and, when the adjustment switch is in an unlocked state, the stop portion is located on a movement path of the first switch controlling the starting and stopping of the motor and the first switch is restricted from implementing a function of starting the motor.

8. The handheld power tool of claim 7, wherein the adjustment device is provided with a locking hole, the adjustment switch further comprises a button for the user to operate, a first seesaw rotatably connected to the handle, and a reset torsion spring connected to the first seesaw, the button is capable of pressing one end of the first seesaw, and another end of the first seesaw is selectively inserted into the locking hole.

9. The handheld power tool of claim 8, wherein the adjustment device comprises a first connecting rod connected to the handle and provided with the locking hole.

10. The handheld power tool of claim 9, further comprising a body housing, wherein the motor is disposed in the body housing, the output assembly is at least partially disposed in the body housing, and the adjustment device further comprises a second connecting rod connected to the body housing.

11. The handheld power tool of claim 10, wherein a locking assembly is disposed between the first connecting rod and the second connecting rod, and, when both the first connecting rod and the second connecting rod extend out of the handle, the locking assembly locks the first connecting rod and the second connecting rod.

12. The handheld power tool of claim 1, further comprising a coupling portion configured to mount a battery pack, wherein the handheld power tool further comprises a spring wire, the spring wire is inserted through the handle and the adjustment device, one end of the spring wire is electrically connected to the motor, and another end of the spring wire is electrically connected to the battery pack.

13. The handheld power tool of claim 1, further comprising a power supply device for supplying electric power to at least the motor, wherein the power supply device is detachably connected to a rear part of the handle.

14. The handheld power tool of claim 1, wherein the first effective length (T1) is less than or equal to 60 cm.

15. The handheld power tool of claim 1, wherein the first effective length (T1) is less than or equal to 50 cm.

16. The handheld power tool of claim 1, wherein the adjustment device is at least partially disposed between the output assembly and the handle.

17. The handheld power tool of claim 1, wherein the handheld power tool is a chainsaw, electric scissors, a nail gun, or a reciprocating saw.

18. A handheld power tool, comprising:
a motor accommodated in a body housing;
a handle for a user to hold; and
an output assembly configured to perform an output operation;
wherein, when the handheld power tool is placed on a horizontal plane, a maximum distance of the handheld power tool along a direction parallel to the horizontal plane is a total length of the handheld power tool, and the total length is adjustable, the handheld power tool has at least a first working state and a second working state, when the handheld power tool is in the first working state, the handheld power tool has a first total length (M1), when the handheld power tool is in the second working state, the handheld power tool has a second total length (M2), the second total length (M2) is greater than the first total length (M1), and the first total length (M1) is less than 1.2 m.

19. The handheld power tool of claim 18, comprising a first switch, wherein only the first switch is usable for controlling starting and stopping of the motor and the first switch is capable of controlling the starting and stopping of the motor when the handheld power tool is in different working states.

20. A one-handed saw, comprising:
a motor accommodated in a body housing;
a handle for a user to hold; and
an output assembly configured to perform an output operation;
wherein, when the one-handed saw is placed on a horizontal plane, a maximum distance of the one-handed saw along a direction parallel to the horizontal plane is a total length of the one-handed saw, and the total length is adjustable.
